(19) United States
(12) Patent Application Publication
(10) Pub. No.: US 2021/0144694 A1
(43) Pub. Date: May 13, 2021

(54) METHOD FOR TRANSMITTING/RECEIVING UPLINK PHYSICAL CHANNEL IN WIRELESS COMMUNICATION SYSTEM, AND DEVICE THEREFOR

(71) Applicant: LG Electronics Inc., Seoul (KR)

(72) Inventors: Hyunho LEE, Seoul (KR); Hanjun PARK, Seoul (KR); Duckhyun BAE, Seoul (KR); Yunjung YI, Seoul (KR)

(21) Appl. No.: 16/644,102

(22) PCT Filed: Jul. 31, 2019
(86) PCT No.: PCT/KR2019/009552

§ 371 Date: Mar. 3, 2020

Related U.S. Application Data
(60) Provisional application No. 62/719,690, filed on Aug. 19, 2018.
(60) Provisional application No. 62/712,930, filed on Jul. 31, 2018.

(51) Int. Cl. H04W 72/04; H04L 1/16; H04W 72/12; H04L 5/00

(52) U.S. Cl. CPC H04W 72/048; H04L 1/1678; H04W 72/042; H04L 5/0055; H04W 72/1268

(57) ABSTRACT

Disclosed herein is a method for transmitting and receiving an Uplink Physical Channel in a wireless communication system and a device for the same. Particularly, the method performed by a User Equipment may include receiving, from a base station, a Physical Downlink Shared Channel (PDSCH); and transmitting, to the base station, the Uplink Physical Channel including Hybrid Automatic Repeat request (HARQ)-Acknowledgement (ACK) information for the PDSCH, wherein the PDSCH may include a first PDSCH related to a first service type and a second PDSCH related to a second service type, and wherein the HARQ-ACK information for the first PDSCH may be included in a HARQ-ACK codebook which is different from a HARQ-ACK codebook including the HARQ-ACK information for the second PDSCH.

### TECHNICAL FIELD

The present disclosure relates to a wireless communication system and, more particularly, to a method for transmitting and receiving an Uplink Physical Channel including Hybrid Automatic Repeat request (HARQ)-Acknowledgement (ACK) information and an apparatus for supporting the same.

### BACKGROUND ART

A mobile communication system has been developed to provide a voice service while ensuring an activity of a user. However, in the mobile communication system, not only a voice but also a data service is extended. At present, due to an explosive increase in traffic, there is a shortage of resources and users demand a higher speed service, and as a result, a more developed mobile communication system is required.

Requirements of a next-generation mobile communication system should be able to support acceptance of explosive data traffic, a dramatic increase in per-user data rate, acceptance of a significant increase in the number of connected devices, very low end-to-end latency, and high-energy efficiency. To this end, various technologies are researched, which include dual connectivity, massive multiple input multiple output (MIMO), in-band full duplex, non-orthogonal multiple access (NOMA), super wideband support, device networking, and the like.

### DISCLOSURE

### Technical Problem

The present disclosure proposes a method for configuring HARQ-ACK bit for downlink data having different service types with HARQ-ACK codebook.

In addition, the present disclosure proposes a method for configuring a service type for downlink data.

In addition, the present disclosure proposes a method for transmitting sub-slot-based HARQ-ACK feedback based on a sub-slot.

Technical problems to be solved by the present disclosure are not limited by the above-mentioned technical problems, and other technical problems which are not mentioned above can be clearly understood from the following description by those skilled in the art to which the present disclosure pertains.

### Technical Solution

The present disclosure proposes a method for transmitting an Uplink Physical Channel in a wireless communication system. The method performed by a User Equipment may include receiving, from a base station, a Physical Downlink Shared Channel (PDSCH); and transmitting, to the base station, the Uplink Physical Channel including Hybrid Automatic Repeat request (HARQ)-Acknowledgement (ACK) information for the PDSCH, wherein the PDSCH may include a first PDSCH related to a first service type and a second PDSCH related to a second service type, and wherein the HARQ-ACK information for the first PDSCH may be included in a HARQ-ACK codebook which is different from a HARQ-ACK codebook including the HARQ-ACK information for the second PDSCH.

In addition, according to the method of the present disclosure, the first PDSCH includes a Transmission Time Unit, a numerology, or a processing time which is different from that of the second PDSCH.

In addition, according to the method of the present disclosure, the first service type and the second service type may be determined by a format of Downlink Control Information (DCI) that schedules a PDSCH, service type information included in the DCI, a Radio Network Temporary Identifier (RNTI) CRC-scrambled in the DCI, a Control Resource Set (CORESET) in which the DCI is received or a search space in which the DCI is monitored.

In addition, the method of the present disclosure may further include receiving a higher layer signal including a set of PDSCH processing times related to each service type.

In addition, the method of the present disclosure may further include receiving, from the base station, configuration information for performing transmission and reception in a sub-slot unit.

In addition, according to the method of the present disclosure, the first PDSCH may include PDSCHs in which HARQ-ACK transmission slot is indicated as a specific slot among PDSCHs received in a first sub-slot of each slot, wherein the second PDSCH may include PDSCHs in which HARQ-ACK transmission slot is indicated as the specific slot among PDSCHs received in a second sub-slot of each slot, wherein the Uplink Physical Channel may include a first Uplink Physical Channel transmitted in the first sub-slot of the specific slot and a second Uplink Physical Channel transmitted in the second sub-slot of the specific slot, and wherein the first Uplink Physical Channel may include the HARQ-ACK information for the first PDSCH, and the second Uplink Physical Channel may include the HARQ-ACK information for the second PDSCH.

In addition, according to the method of the present disclosure, the Uplink Physical Channel may include a Physical Uplink Control Channel (PUCCH) or a Physical Uplink Shared Channel (PUSCH).

In addition, a User Equipment for transmitting an Uplink Physical Channel in a wireless communication system may include a Radio Frequency (RF) Unit for transmission and receiving a radio signal; and a processor functionally connected to the RF unit, wherein the processor is configured to: receive, from a base station, a Physical Downlink Shared Channel (PDSCH); and transmit, to the base station, the Uplink Physical Channel including Hybrid Automatic Repeat request (HARQ)-Acknowledgement (ACK) information for the PDSCH, wherein the PDSCH may include a first PDSCH related to a first service type and a second PDSCH related to a second service type, and wherein the HARQ-ACK information for the first PDSCH may be included in a HARQ-ACK codebook which is different from a HARQ-ACK codebook including the HARQ-ACK information for the second PDSCH.

In addition, according to the User Equipment of the present disclosure, the first PDSCH may include a Transmission Time Unit, a numerology, or a processing time which is different from that of the second PDSCH.

In addition, according to the User Equipment of the present disclosure, the first service type and the second service type may be determined by a format of Downlink Control Information (DCI) that schedules a PDSCH, service type information included in the DCI, a Radio Network Temporary Identifier (RNTI) CRC-scrambled to the DCI, a Control Resource Set (CORESET) in which the DCI is received or a search space in which the DCI is monitored.

In addition, according to the User Equipment of the present disclosure, the processor may be controlled to receive, from the base station, configuration information for performing transmission and reception in a sub-slot unit.

In addition, according to the User Equipment of the present disclosure, the Uplink Physical Channel may include a Physical Uplink Control Channel (PUCCH) or a Physical Uplink Shared Channel (PUSCH).

In addition, a base station for receiving an Uplink Physical Channel in a wireless communication system according to the present disclosure may include a Radio Frequency (RF) Unit for transmission and receiving a radio signal; and a processor functionally connected to the RF unit, wherein the processor is configured to: transmit, to a User Equipment, a Physical Downlink Shared Channel (PDSCH); and receive, from the User Equipment, the Uplink Physical Channel including Hybrid Automatic Repeat request (HARQ)-Acknowledgement (ACK) information for the PDSCH, wherein the PDSCH includes a first PDSCH related to a first service type and a second PDSCH related to a second service type, and wherein the HARQ-ACK information for the first PDSCH is included in a HARQ-ACK codebook which is different from a HARQ-ACK codebook including the HARQ-ACK information for the second PDSCH.

In addition, according to the base station of the present disclosure, the first PDSCH may include a Transmission Time Unit, a numerology, or a processing time which is different from that of the second PDSCH.

In addition, according to the base station of the present disclosure, the Uplink Physical Channel may include a Physical Uplink Control Channel (PUCCH) or a Physical Uplink Shared Channel (PUSCH).

### Advantageous Effects

According to the present disclosure, a communication system having low latency and ultra-reliability can be implemented.

Effects obtainable from the present disclosure are not limited by the effects mentioned above, and other effects which are not mentioned above can be clearly understood from the following description by those skilled in the art to which the present disclosure pertains.

### DESCRIPTION OF DRAWINGS

The accompanying drawings, which are included to provide a further understanding of the present disclosure and constitute a part of the detailed description, illustrate embodiments of the present disclosure and together with the description serve to explain the principle of the present disclosure.

FIG. 1 is a diagram showing an AI device to which a method proposed in this specification may be applied.

FIG. 2 is a diagram showing an AI server to which a method proposed in this specification may be applied.

FIG. 3 is a diagram showing an AI system to which a method proposed in this specification may be applied.

FIG. 4 illustrates an example of an overall structure of a NR system to which a method proposed by the present specification is applicable.

FIG. 5 illustrates a relation between an uplink frame and a downlink frame in a wireless communication system to which a method proposed by the present specification is applicable.

FIG. 6 illustrates an example of a frame structure in a NR system.

FIG. 7 illustrates an example of a resource grid supported in a wireless communication system to which a method proposed by the present specification is applicable.

FIG. 8 illustrates examples of a resource grid per antenna port and numerology to which a method proposed by the present specification is applicable.

FIG. 9 illustrates an example of a self-contained structure to which a method proposed by the present specification is applicable.

FIG. 10 is a flowchart for describing an operation method of a UE proposed in the present disclosure.

FIG. 11 is a flowchart for describing an operation method of a base station proposed in the present disclosure.

FIG. 12 illustrates a block configuration diagram of a wireless communication device to which methods proposed by the present specification are applicable.

FIG. 13 illustrates a block configuration diagram of a communication device according to an embodiment of the present disclosure.

FIG. 14 illustrates an example of a RF module of a wireless communication device to which a method proposed by the present specification is applicable.

FIG. 15 illustrates another example of a RF module of a wireless communication device to which a method proposed by the present specification is applicable.

FIG. 16 is a diagram illustrating an example of a signal processing module to which the methods proposed in the present disclosure is applicable.

FIG. 17 is a diagram illustrating another example of a signal processing module to which the methods proposed in the present disclosure is applicable.

### MODE FOR INVENTION

Reference will now be made in detail to embodiments of the invention, examples of which are illustrated in the accompanying drawings. A detailed description to be disclosed below together with the accompanying drawing is to describe exemplary embodiments of the present disclosure and not to describe a unique embodiment for carrying out the present disclosure. The detailed description below includes details to provide a complete understanding of the present disclosure. However, those skilled in the art know that the present disclosure can be carried out without the details.

In some cases, in order to prevent a concept of the present disclosure from being ambiguous, known structures and devices may be omitted or illustrated in a block diagram format based on core functions of each structure and device.

In the present disclosure, a base station (BS) means a terminal node of a network directly performing communication with a terminal. In the present disclosure, specific operations described to be performed by the base station may be performed by an upper node of the base station, if necessary or desired. That is, it is obvious that in the network consisting of multiple network nodes including the base station, various operations performed for communication with the terminal can be performed by the base station or network nodes other than the base station. The ‘base station (BS)’ may be replaced with terms such as a fixed station, Node B, evolved-NodeB (eNB), a base transceiver system (BTS), an access point (AP), gNB (general NB), and the like. Further, a ‘terminal’ may be fixed or movable and may be replaced with terms such as user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, a device-to-device (D2D) device, and the like.

In the present disclosure, downlink (DL) means communication from the base station to the terminal, and uplink (UL) means communication from the terminal to the base station. In the downlink, a transmitter may be a part of the base station, and a receiver may be a part of the terminal. In the uplink, the transmitter may be a part of the terminal, and the receiver may be a part of the base station.

Specific terms used in the following description are provided to help the understanding of the present disclosure, and may be changed to other forms within the scope without departing from the technical spirit of the present disclosure.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology such as universal terrestrial radio access (UTRA) or CDMA2000. The TDMA may be implemented by radio technology such as global system for mobile communications (GSM)/general packet radio service (GPRS)/enhanced data rates for GSM evolution (EDGE). The OFDMA may be implemented as radio technology such as IEEE 802.11 (Wi-Fi), IEEE 802.16 (WiMAX), IEEE 802-20, E-UTRA (evolved UTRA), and the like. The UTRA is a part of a universal mobile telecommunication system (UMTS). 3rd generation partnership project (3GPP) long term evolution (LTE), as a part of an evolved UMTS (E-UMTS) using E-UTRA, adopts the OFDMA in the downlink and the SC-FDMA in the uplink. LTE-A (advanced) is the evolution of 3GPP LTE.

Embodiments of the present disclosure can be supported by standard documents disclosed in at least one of IEEE 802, 3GPP, and 3GPP2 which are the wireless access systems. That is, steps or parts in embodiments of the present disclosure which are not described to clearly show the technical spirit of the present disclosure can be supported by the standard documents. Further, all terms described in the present disclosure can be described by the standard document.

3GPP LTE/LTE-A/New RAT (NR) is primarily described for clear description, but technical features of the present disclosure are not limited thereto.

Hereinafter, examples of 5G use scenarios to which a method proposed in this specification may be applied are described.

Three major requirement areas of 5G include (1) an enhanced mobile broadband (eMBB) area, (2) a massive machine type communication (mMTC) area and (3) an ultra-reliable and low latency communications (URLLC) area.

Some use cases may require multiple areas for optimization, and other use case may be focused on only one key performance indicator (KPI). 5G support such various use cases in a flexible and reliable manner.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this may be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link having ultra reliability/low available latency, such as a self-driving vehicle. A level of reliability and latency is essential for smart grid control, industry automation, robot engineering, drone control and adjustment.

Multiple use cases are described more specifically.

5G may supplement fiber-to-the-home (FTTH) and cable-based broadband (or DOCSIS) as means for providing a stream evaluated from gigabits per second to several hundreds of mega bits per second. Such fast speed is necessary to deliver TV with resolution of 4K or more (6K, 8K or more) in addition to virtual reality and augmented reality. Virtual reality (VR) and augmented reality (AR) applications include immersive sports games. A specific application program may require a special network configuration. For example, in the case of VR game, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between automotives, information exchange between an automotive and a supported infrastructure, and information exchange between an automotive and other connected devices (e.g., devices accompanied by a pedestrian). A safety system guides alternative courses of a behavior so that a driver can drive more safely, thereby reducing a danger of an accident. A next step will be a remotely controlled or self-driven vehicle. This requires very reliable, very fast communication between different self-driven vehicles and between an automotive and infra. In the future, a self-driven vehicle may perform all driving activities, and a driver will be focused on things other than traffic, which cannot be identified by an automotive itself. Technical requirements of a self-driven vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system can support remote treatment providing clinical treatment at a distant place. This helps to reduce a barrier for the distance and can improve access to medical services which are not continuously used at remote farming areas. Furthermore, this is used to save life in important treatment and an emergency condition. A radio sensor network based on mobile communication can provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

Artificial Intelligence (AI)

Artificial intelligence means the field in which artificial intelligence or methodology capable of producing artificial intelligence is researched. Machine learning means the field in which various problems handled in the artificial intelligence field are defined and methodology for solving the problems are researched. Machine learning is also defined as an algorithm for improving performance of a task through continuous experiences for the task.

An artificial neural network (ANN) is a model used in machine learning, and is configured with artificial neurons (nodes) forming a network through a combination of synapses, and may mean the entire model having a problem-solving ability. The artificial neural network may be defined by a connection pattern between the neurons of different layers, a learning process of updating a model parameter, and an activation function for generating an output value.

The artificial neural network may include an input layer, an output layer, and optionally one or more hidden layers. Each layer includes one or more neurons. The artificial neural network may include a synapse connecting neurons. In the artificial neural network, each neuron may output a function value of an activation function for input signals, weight, and a bias input through a synapse.

A model parameter means a parameter determined through learning, and includes the weight of a synapse connection and the bias of a neuron. Furthermore, a hyper parameter means a parameter that needs to be configured prior to learning in the machine learning algorithm, and includes a learning rate, the number of times of repetitions, a mini-deployment size, and an initialization function.

An object of learning of the artificial neural network may be considered to determine a model parameter that minimizes a loss function. The loss function may be used as an index for determining an optimal model parameter in the learning process of an artificial neural network.

Machine learning may be classified into supervised learning, unsupervised learning, and reinforcement learning based on a learning method.

Supervised learning means a method of training an artificial neural network in the state in which a label for learning data has been given. The label may mean an answer (or a result value) that must be deduced by an artificial neural network when learning data is input to the artificial neural network. Unsupervised learning may mean a method of training an artificial neural network in the state in which a label for learning data has not been given. Reinforcement learning may mean a learning method in which an agent defined within an environment is trained to select a behavior or behavior sequence that maximizes accumulated compensation in each state.

Machine learning implemented as a deep neural network (DNN) including a plurality of hidden layers, among artificial neural networks, is also called deep learning. Deep learning is part of machine learning. Hereinafter, machine learning is used as a meaning including deep learning.

Robot

A robot may mean a machine that automatically processes a given task or operates based on an autonomously owned ability. Particularly, a robot having a function for recognizing an environment and autonomously determining and performing an operation may be called an intelligence type robot.

A robot may be classified for industry, medical treatment, home, and military based on its use purpose or field.

A robot includes a driving unit including an actuator or motor, and may perform various physical operations, such as moving a robot joint. Furthermore, a movable robot includes a wheel, a brake, a propeller, etc. in a driving unit, and may run on the ground or fly in the air through the driving unit.

Self-Driving (Autonomous-Driving)

Self-driving means a technology for autonomous driving. A self-driving vehicle means a vehicle that runs without a user manipulation or by a user's minimum manipulation.

For example, self-driving may include all of a technology for maintaining a driving lane, a technology for automatically controlling speed, such as adaptive cruise control, a technology for automatic driving along a predetermined path, a technology for automatically configuring a path when a destination is set and driving.

A vehicle includes all of a vehicle having only an internal combustion engine, a hybrid vehicle including both an internal combustion engine and an electric motor, and an electric vehicle having only an electric motor, and may include a train, a motorcycle, etc. in addition to the vehicles.

In this case, the self-driving vehicle may be considered to be a robot having a self-driving function.

Extended Reality (XR)

Extended reality collectively refers to virtual reality (VR), augmented reality (AR), and mixed reality (MR). The VR technology provides an object or background of the real world as a CG image only. The AR technology provides a virtually produced CG image on an actual thing image. The MR technology is a computer graphics technology for mixing and combining virtual objects with the real world and providing them.

The MR technology is similar to the AR technology in that it shows a real object and a virtual object. However, in the AR technology, a virtual object is used in a form to supplement a real object. In contrast, unlike in the AR technology, in the MR technology, a virtual object and a real object are used as the same character.

The XR technology may be applied to a head-mount display (HMD), a head-up display (HUD), a mobile phone, a tablet PC, a laptop, a desktop, TV, and a digital signage. A device to which the XR technology has been applied may be called an XR device.

FIG. 1 is a diagram showing an AI device 100 to which a method proposed in this specification may be applied.

The AI device 100 may be implemented as a fixed device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, a digital signage, a robot, and a vehicle.

Referring to FIG. 1, the terminal 100 may include a communication unit 110, an input unit 120, a learning processor 130, a sensing unit 140, an output unit 150, memory 170 and a processor 180.

The communication unit 110 may transmit and receive data to and from external devices, such as other AI devices 100a to 100er or an AI server 200, using wired and wireless communication technologies. For example, the communication unit 110 may transmit and receive sensor information, a user input, a learning model, and a control signal to and from external devices.

In this case, communication technologies used by the communication unit 110 include a global system for mobile communication (GSM), code division multi access (CDMA), long term evolution (LTE), 5G, a wireless LAN (WLAN), wireless-fidelity (Wi-Fi), Bluetooth™, radio frequency identification (RFID), infrared data association (IrDA), ZigBee, near field communication (NFC), etc.

The input unit 120 may obtain various types of data.

In this case, the input unit 120 may include a camera for an image signal input, a microphone for receiving an audio signal, a user input unit for receiving information from a user, etc. In this case, the camera or the microphone is treated as a sensor, and a signal obtained from the camera or the microphone may be called sensing data or sensor information.

The input unit 120 may obtain learning data for model learning and input data to be used when an output is obtained using a learning model. The input unit 120 may obtain not-processed input data. In this case, the processor 180 or the learning processor 130 may extract an input feature by performing pre-processing on the input data.

The learning processor 130 may be trained by a model configured with an artificial neural network using learning data. In this case, the trained artificial neural network may be called a learning model. The learning model is used to deduce a result value of new input data not learning data. The deduced value may be used as a base for performing a given operation.

In this case, the learning processor 130 may perform AI processing along with the learning processor 240 of the AI server 200.

In this case, the learning processor 130 may include memory integrated or implemented in the AI device 100. Alternatively, the learning processor 130 may be implemented using the memory 170, external memory directly coupled to the AI device 100 or memory maintained in an external device.

The sensing unit 140 may obtain at least one of internal information of the AI device 100, surrounding environment information of the AI device 100, or user information using various sensors.

In this case, sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, LIDAR, and a radar.

The output unit 150 may generate an output related to a visual sense, an auditory sense or a tactile sense.

In this case, the output unit 150 may include a display unit for outputting visual information, a speaker for outputting auditory information, and a haptic module for outputting tactile information.

The memory 170 may store data supporting various functions of the AI device 100. For example, the memory 170 may store input data obtained by the input unit 120, learning data, a learning model, a learning history, etc.

The processor 180 may determine at least one executable operation of the AI device 100 based on information, determined or generated using a data analysis algorithm or a machine learning algorithm. Furthermore, the processor 180 may perform the determined operation by controlling elements of the AI device 100.

To this end, the processor 180 may request, search, receive, and use the data of the learning processor 130 or the memory 170, and may control elements of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 may obtain intention information for a user input and transmit user requirements based on the obtained intention information.

In this case, the processor 180 may obtain the intention information, corresponding to the user input, using at least one of a speech to text (STT) engine for converting a voice input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 18 may control at least some of the elements of the AI device 100 in order to execute an application program stored in the memory 170. Moreover, the processor 180 may combine and drive two or more of the elements included in the AI device 100 in order to execute the application program.

FIG. 2 is a diagram showing the AI server 200 to which a method proposed in this specification may be applied.

Referring to FIG. 2, the AI server 200 may mean a device which is trained by an artificial neural network using a machine learning algorithm or which uses a trained artificial neural network. In this case, the AI server 200 is configured with a plurality of servers and may perform distributed processing and may be defined as a 5G network. In this case, the AI server 200 may be included as a partial configuration of the AI device 100, and may perform at least some of AI processing.

The AI server 200 may include a communication unit 210, memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If some of or the entire learning model is implemented as software, one or more instructions configuring the learning model may be stored in the memory 230.

The processor 260 may deduce a result value of new input data using the learning model, and may generate a response or control command based on the deduced result value.

FIG. 3 is a diagram showing an AI system 1 to which a method proposed in this specification may be applied.

Referring to FIG. 3, the AI system 1 is connected to at least one of the AI server 200, a robot 100a, a self-driving vehicle 100b, an XR device 100c, a smartphone 100d or home appliances 100e over a cloud network 10. In this case, the robot 100a, the self-driving vehicle 100b, the XR device 100c, the smartphone 100d or the home appliances 100e to which the AI technology has been applied may be called AI devices 100a to 100e.

The cloud network 10 may configure part of cloud computing infra or may mean a network present within cloud computing infra. In this case, the cloud network 10 may be configured using the 3G network, the 4G or long term evolution (LTE) network or the 5G network.

That is, the devices 100a to 100e (200) configuring the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100d or the home appliances 100e, that is, AI devices configuring the AI system 1, over the cloud network 10, and may help at least some of the AI processing of the connected AI devices 100a to 100e.

In this case, the AI server 200 may train an artificial neural network based on a machine learning algorithm in place of the AI devices 100a to 100e, may directly store a learning model or may transmit the learning model to the AI devices 100a to 100e.

In this case, the AI server 200 may receive input data from the AI devices 100a to 100e, may deduce a result value of the received input data using the learning model, may generate a response or control command based on the deduced result value, and may transmit the response or control command to the AI devices 100a to 100e.

Alternatively, the AI devices 100a to 100e may directly deduce a result value of input data using a learning model, and may generate a response or control command based on the deduced result value.

Hereinafter, various embodiments of the AI devices 100a to 100e to which the above-described technology is applied are described. In this case, the AI devices 100a to 100e shown in FIG. 3 may be considered to be detailed embodiments of the AI device 100 shown in FIG. 1.

AI+Robot

An AI technology is applied to the robot 100a, and the robot 100a may be implemented as a guidance robot, a transport robot, a cleaning robot, a wearable robot, an entertainment robot, a pet robot, an unmanned flight robot, etc.

The robot 100a may include a robot control module for controlling an operation. The robot control module may mean a software module or a chip in which a software module has been implemented using hardware.

The robot 100a may obtain state information of the robot 100a, may detect (recognize) a surrounding environment and object, may generate map data, may determine a moving path and a running plan, may determine a response to a user interaction, or may determine an operation using sensor information obtained from various types of sensors.

In this case, the robot 100a may use sensor information obtained by at least one sensor among LIDAR, a radar, and a camera in order to determine the moving path and running plan.

The robot 100a may perform the above operations using a learning model configured with at least one artificial neural network. For example, the robot 100a may recognize a surrounding environment and object using a learning model, and may determine an operation using recognized surrounding environment information or object information. In this case, the learning model may have been directly trained in the robot 100a or may have been trained in an external device, such as the AI server 200.

In this case, the robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driving unit.

The map data may include object identification information for various objects disposed in the space in which the robot 100a moves. For example, the map data may include object identification information for fixed objects, such as a wall and a door, and movable objects, such as a flowport and a desk. Furthermore, the object identification information may include a name, a type, a distance, a location, etc.

Furthermore, the robot 100a may perform an operation or run by controlling the driving unit based on a user's control/interaction. In this case, the robot 100a may obtain intention information of an interaction according to a user's behavior or voice speaking, may determine a response based on the obtained intention information, and may perform an operation.

AI+Self-Driving

An AI technology is applied to the self-driving vehicle 100b, and the self-driving vehicle 100b may be implemented as a movable type robot, a vehicle, an unmanned flight body, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as an element of the self-driving vehicle 100b, but may be configured as separate hardware outside the self-driving vehicle 100b and connected to the self-driving vehicle 100b.

The self-driving vehicle 100b may obtain state information of the self-driving vehicle 100b, may detect (recognize) a surrounding environment and object, may generate map data, may determine a moving path and running plan, or may determine an operation using sensor information obtained from various types of sensors.

In this case, in order to determine the moving path and running plan, like the robot 100a, the self-driving vehicle 100b may use sensor information obtained from at least one sensor among LIDAR, a radar and a camera.

Particularly, the self-driving vehicle 100b may recognize an environment or object in an area whose view is blocked or an area of a given distance or more by receiving sensor information for the environment or object from external devices, or may directly receive recognized information for the environment or object from external devices.

The self-driving vehicle 100b may perform the above operations using a learning model configured with at least one artificial neural network. For example, the self-driving vehicle 100b may recognize a surrounding environment and object using a learning model, and may determine the flow of running using recognized surrounding environment information or object information. In this case, the learning model may have been directly trained in the self-driving vehicle 100b or may have been trained in an external device, such as the AI server 200.

In this case, the self-driving vehicle 100b may directly generate results using the learning model and perform an operation, but may perform an operation by transmitting sensor information to an external device, such as the AI server 200, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driving unit.

The map data may include object identification information for various objects disposed in the space (e.g., road) in which the self-driving vehicle 100b runs. For example, the map data may include object identification information for fixed objects, such as a streetlight, a rock, and a building, etc., and movable objects, such as a vehicle and a pedestrian. Furthermore, the object identification information may include a name, a type, a distance, a location, etc.

Furthermore, the self-driving vehicle 100b may perform an operation or may run by controlling the driving unit based on a user's control/interaction. In this case, the self-driving vehicle 100b may obtain intention information of an interaction according to a user' behavior or voice speaking, may determine a response based on the obtained intention information, and may perform an operation.

AI+XR

An AI technology is applied to the XR device 100c, and the XR device 100c may be implemented as a head-mount display, a head-up display provided in a vehicle, television, a mobile phone, a smartphone, a computer, a wearable device, home appliances, a digital signage, a vehicle, a fixed type robot or a movable type robot.

The XR device 100c may generate location data and attributes data for three-dimensional points by analyzing three-dimensional point cloud data or image data obtained through various sensors or from an external device, may obtain information on a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

AI+Robot+Self-Driving

An AI technology and a self-driving technology are applied to the robot 100a, and the robot 100a may be implemented as a guidance robot, a transport robot, a cleaning robot, a wearable robot, an entertainment robot, a pet robot, an unmanned flight robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously move along a given flow without control of a user or autonomously determine a flow and move.

The robot 100a and the self-driving vehicle 100b having the self-driving function may use a common sensing method in order to determine one or more of a moving path or a running plan. For example, the robot 100a and the self-driving vehicle 100b having the self-driving function may determine one or more of a moving path or a running plan using information sensed through LI DAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driving unit of the self-driving vehicle 100b. In this case, the function of the self-driving vehicle 100b controlled by the robot 100a may include a function provided by a navigation system or audio system provided within the self-driving vehicle 100b, in addition to a self-driving function simply.

Alternatively, the robot 100a interacting with the self-driving vehicle 100b may provide information to the self-driving vehicle 100b or may assist a function outside the self-driving vehicle 100b. For example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

AI+Robot+XR

An AI technology and an XR technology are applied to the robot 100a, and the robot 100a may be implemented as a guidance robot, a transport robot, a cleaning robot, a wearable robot, an entertainment robot, a pet robot, an unmanned flight robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

AI+Self-Driving+XR

An AI technology and an XR technology are applied to the self-driving vehicle 100b, and the self-driving vehicle 100b may be implemented as a movable type robot, a vehicle, an unmanned flight body, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

When the self-driving vehicle 100b, that is, a target of control/interaction within an XR image, obtains sensor information from sensors including a camera, the self-driving vehicle 100b or the XR device 100c may generate an XR image based on the sensor information. The XR device 100c may output the generated XR image. Furthermore, the self-driving vehicle 100b may operate based on a control signal received through an external device, such as the XR device 100c, or a user's interaction.

As propagation of smart phones and Internet of things (IoT) UEs rapidly spreads, the amount of information increase, which is transmitted and received through a communication network. Accordingly, in the next generation wireless access technology, an environment (e.g., enhanced mobile broadband communication) that provides a faster service to more users than existing communication systems (or existing radio access technology) needs to be considered.

To this end, a design of a communication system that considers machine type communication (MTC) providing a service by connecting multiple devices and objects is discussed. Further, a design of a communication system (e.g., Ultra-Reliable and Low Latency Communication (URLLC)) considering a service and/or a terminal sensitive to reliability and/or latency of communication is also discussed.

Hereinafter, in the present disclosure, for the convenience of description, the next-generation wireless access technology is referred to as a new radio access technology (RAT) (NR) radio access technology and the wireless communication system to which the NR is applied is referred to as an NR system.

### Definition of Terms

eLTE eNB: The eLTE eNB is the evolution of eNB that supports connectivity to EPC and NGC.

gNB: A node which supports the NR as well as connectivity to NGC.

New RAN: A radio access network which supports either NR or E-UTRA or interfaces with the NGC.

Network slice: A network slice is a network created by the operator customized to provide an optimized solution for a specific market scenario which demands specific requirements with end-to-end scope.

Network function: A network function is a logical node within a network infrastructure that has well-defined external interfaces and well-defined functional behaviour.

NG-C: A control plane interface used on NG2 reference points between new RAN and NGC.

NG-U: A user plane interface used on NG3 references points between new RAN and NGC.

Non-standalone NR: A deployment configuration where the gNB requires an LTE eNB as an anchor for control plane connectivity to EPC, or requires an eLTE eNB as an anchor for control plane connectivity to NGC.

Non-standalone E-UTRA: A deployment configuration where the eLTE eNB requires a gNB as an anchor for control plane connectivity to NGC.

User plane gateway: A termination point of NG-U interface.

General System

FIG. 4 illustrates an example of the entire system architecture to which the method proposed in the present disclosure may be applied.

Referring to FIG. 4, NG-RAN includes gNBs that provide a control plane (RRC) protocol terminal for an NG-RA user plane (new AS sublayer/PDCP/RLC/MAC/PHY) and a User Equipment (UE).

The gNBs are connected with each other through Xn interface.

The gNB is also connected to an NGC through NG interface.

More particularly, the gNB is connected to the Access and Mobility Management Function (AMF) through N2 interface and connected to the User Plane Function (UPF) through N3 interface.

NR (New Rat) Numerology and frame structure

In the NR system, multiple numerologies may be supported. The numerologies may be defined by subcarrier spacing and a CP (Cyclic Prefix) overhead. Spacing between the plurality of subcarriers may be derived by scaling basic subcarrier spacing into an integer N (or μ). In addition, although a very low subcarrier spacing is assumed not to be used at a very high subcarrier frequency, a numerology to be used may be selected independent of a frequency band.

In addition, in the NR system, a variety of frame structures according to the multiple numerologies may be supported.

Hereinafter, an orthogonal frequency division multiplexing (OFDM) numerology and a frame structure, which may be considered in the NR system, will be described.

A plurality of OFDM numerologies supported in the NR system may be defined as in Table 1.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |

Regarding a frame structure in the NR system, a size of various fields in the time domain is expressed as a multiple of a time unit of Tₛ=1/(Δfₘₐₓ·N_{f}). In this case, Δfₘₐₓ=480·10³, and N_{f}=4096. DL and UL transmission is configured as a radio frame having a section of T_{f}=(ΔfₘₐₓN_{f}/100)·Tₛ=10 ms. The radio frame is composed of ten subframes each having a section of T_{sf}=(ΔfₘₐₓN_{f}/1000)·Tₛ=1 ms. In this case, there may be a set of UL frames and a set of DL frames.

FIG. 5 illustrates a relation between an uplink frame and a downlink frame in a wireless communication system to which a method proposed by the present specification is applicable.

As illustrated in FIG. 5, uplink frame number i for transmission from a user equipment (UE) shall start T_{TA}=N_{TA}Tₛ before the start of a corresponding downlink frame at the corresponding UE.

Regarding the numerology μ, slots are numbered in increasing order of nₛ^{μ}∈{0, . . . , N_{subframe}^{slots, μ}−1} within a subframe and are numbered in increasing order of n_{s,f}^{μ}∈{0, . . . , N_{frame}^{slots,μ}−1} within a radio frame. One slot consists of consecutive OFDM symbols of N_{symb}^{μ}, and N_{symb}^{μ} is determined depending on a numerology used and slot configuration. The start of slots nₛ^{μ} in a subframe is aligned in time with the start of OFDM symbols nₛ^{μ}N_{symb}^{μ} in the same subframe.

Not all UEs are able to transmit and receive at the same time, and this means that not all OFDM symbols in a downlink slot or an uplink slot are available to be used.

Table 2 represents the number N_{symb}^{slot} of OFDM symbols per slot, the number Nₛₗₒₜ^{frame,μ} of slots per radio frame, and the number Nₛₗₒₜ^{subframe,μ} of slots per subframe in a normal CP. Table 3 represents the number of OFDM symbols per slot, the number of slots per radio frame, and the number of slots per subframe in an extended CP.

TABLE 2

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | N_{symb}^{slot} | Nₛₗₒₜ^{frame,μ} | Nₛₗₒₜ^{subframe,μ} |
|---|---|---|---|
| 2 | 12 | 40 | 4 |

FIG. 6 illustrates an example of a frame structure in a NR system. FIG. 6 is merely for convenience of explanation and does not limit the scope of the present disclosure.

In Table 3, in case of μ=2, i.e., as an example in which a subcarrier spacing (SCS) is 60 kHz, one subframe (or frame) may include four slots with reference to Table 2, and one subframe={1, 2, 4} slots shown in FIG. 3, for example, the number of slot(s) that may be included in one subframe may be defined as in Table 2.

Further, a mini-slot may consist of 2, 4, or 7 symbols, or may consist of more symbols or less symbols.

In regard to physical resources in the NR system, an antenna port, a resource grid, a resource element, a resource block, a carrier part, etc. may be considered.

Hereinafter, the above physical resources that can be considered in the NR system are described in more detail.

First, in regard to an antenna port, the antenna port is defined so that a channel over which a symbol on an antenna port is conveyed can be inferred from a channel over which another symbol on the same antenna port is conveyed. When large-scale properties of a channel over which a symbol on one antenna port is conveyed can be inferred from a channel over which a symbol on another antenna port is conveyed, the two antenna ports may be regarded as being in a quasi co-located or quasi co-location (QC/QCL) relation. Here, the large-scale properties may include at least one of delay spread, Doppler spread, frequency shift, average received power, and received timing.

FIG. 7 illustrates an example of a resource grid supported in a wireless communication system to which a method proposed by the present specification is applicable.

Referring to FIG. 7, a resource grid consists of N_{RB}^{μ}N_{sc}^{RB} subcarriers on a frequency domain, each subframe consisting of 14·2μ OFDM symbols, but the present disclosure is not limited thereto.

In the NR system, a transmitted signal is described by one or more resource grids, consisting of N_{RB}^{μ}N_{sc}^{RB} subcarriers, and 2^{μ}N_{symb}^{(μ)} OFDM symbols, where N_{RB}^{μ}≤N_{RB}^{max,μ}. N_{RB}^{max,μ} denotes a maximum transmission bandwidth and may change not only between numerologies but also between uplink and downlink.

In this case, as illustrated in FIG. 8, one resource grid may be configured per numerology μ and antenna port p.

FIG. 8 illustrates examples of a resource grid per antenna port and numerology to which a method proposed by the present specification is applicable.

Each element of the resource grid for the numerology μ and the antenna port p is called a resource element and is uniquely identified by an index pair (k,l̅), where k=0, . . . , N_{RB}^{μ}N_{sc}^{RB}−1 is an index on a frequency domain, and l̅=0, . . . , 2^{μ}N_{symb}^{(μ)}−1 refers to a location of a symbol in a subframe. The index pair (k,l̅) is used to refer to a resource element in a slot, where l=0, . . . , N_{symb}^{μ}−1

The resource element (k,l̅) for the numerology μ and the antenna port p corresponds to a complex value a_{k,l̅}^{(p,μ)}. When there is no risk for confusion or when a specific antenna port or numerology is not specified, the indexes p and μ may be dropped, and as a result, the complex value may be a_{k,l̅}^{(p)} or a_{k,l̅}.

Further, a physical resource block is defined as N_{sc}^{RB}=12 consecutive subcarriers in the frequency domain.

Point A serves as a common reference point of a resource block grid and may be obtained as follows.
offsetToPointA for PCell downlink represents a frequency offset between the point A and a lowest subcarrier of a lowest resource block that overlaps a SS/PBCH block used by the UE for initial cell selection, and is expressed in units of resource blocks assuming 15 kHz subcarrier spacing for FR1 and 60 kHz subcarrier spacing for FR2;
absoluteFrequencyPointA represents frequency-location of the point A expressed as in absolute radio-frequency channel number (ARFCN).

The common resource blocks are numbered from 0 and upwards in the frequency domain for subcarrier spacing configuration μ.

The center of subcarrier 0 of common resource block 0 for the subcarrier spacing configuration μ coincides with ‘point A’. A common resource block number n_{CRB}^{μ} in the frequency domain and resource elements (k, l) for the subcarrier spacing configuration μ may be given by the following Equation 1.

$${n}_{CRB}^{μ} = ⌊ \frac{k}{{N}_{s c}^{RB}} ⌋ \qquad [ Equation 1 ]$$

Here, k may be defined relative to the point A so that k=0 corresponds to a subcarrier centered around the point A. Physical resource blocks are defined within a bandwidth part (BWP) and are numbered from 0 to N_{BWP,j}^{size}−1, where i is No. of the BWP. A relation between the physical resource block n_{PRB} in BWP i and the common resource block n_{CRB} may be given by the following Equation 2.

n_{CRB}=n_{PRB}+N_{BWP,i}^{start} [Equation 2]

Here, N_{BWP,i}^{start} may be the common resource block where the BWP starts relative to the common resource block 0.

Self-Contained Structure

A time division duplexing (TDD) structure considered in the NR system is a structure in which both uplink (UL) and downlink (DL) are processed in one slot (or subframe). The structure is to minimize a latency of data transmission in a TDD system and may be referred to as a self-contained structure or a self-contained slot.

FIG. 9 illustrates an example of a self-contained structure to which a method proposed by the present specification is applicable. FIG. 9 is merely for convenience of explanation and does not limit the scope of the present disclosure.

Referring to FIG. 9, as in legacy LTE, it is assumed that one transmission unit (e.g., slot, subframe) consists of 14 orthogonal frequency division multiplexing (OFDM) symbols.

In FIG. 9, a region 902 means a downlink control region, and a region 904 means an uplink control region. Further, regions (i.e., regions without separate indication) other than the region 902 and the region 904 may be used for transmission of downlink data or uplink data.

That is, uplink control information and downlink control information may be transmitted in one self-contained slot. On the other hand, in case of data, uplink data or downlink data is transmitted in one self-contained slot.

When the structure illustrated in FIG. 9 is used, in one self-contained slot, downlink transmission and uplink transmission may sequentially proceed, and downlink data transmission and uplink ACK/NACK reception may be performed.

As a result, if an error occurs in the data transmission, time required until retransmission of data can be reduced. Hence, the latency related to data transfer can be minimized.

In the self-contained slot structure illustrated in FIG. 9, a base station (e.g., eNodeB, eNB, gNB) and/or a user equipment (UE) (e.g., terminal) require a time gap for a process for converting a transmission mode into a reception mode or a process for converting a reception mode into a transmission mode. In regard to the time gap, if uplink transmission is performed after downlink transmission in the self-contained slot, some OFDM symbol(s) may be configured as a guard period (GP).

Bandwidth Part

A bandwidth part (BWP) may be a contiguous subset of the common resource blocks defined for a given numerology μᵢ on a given by BWP i. In the bandwidth part, the starting position N_{BWP,i}^{start,μ} and the number of resource blocks N_{BWP,i}^{start,μ} may need to fulfil N_{grid,x}^{start,μ}≤N_{BWP,i}^{start,μ}<N_{grid,x}^{start,μ}+N_{grid,x}^{size,μ} and N_{grid,x}^{start,μ}≤N_{BWP,i}^{start,μ} N_{BWP,i}^{start,μ}≤N_{grid,x}^{start,μ}+N_{grid,x}^{size,μ}. The configuration of the BWP may be specified in a predefined standard (e.g., clause 12 of 3GPP TS 38.213).

A UE may be configured with up to four BWPs in the downlink with a single downlink BWP being active at a given time. The UE may not be expected to receive PDSCH, PDCCH or CSI-RS (excluding RRM) outside an active BWP.

A UE may be configured with up to four BWPs in the uplink with a single uplink BWP being active at a given time. In the case that the UE is configured with a supplementary uplink, the UE may in addition be configured with up to four BWPs in the supplementary uplink with a single supplementary uplink BWP being active at a given time. The UE may not transmit PUSCH or PUCCH outside an active BWP. For an active cell, the UE may not transmit SRS outside an active BWP.

Unless otherwise described, the description in the present disclosure may be applied to respective BWPs.

In addition, transmissions in multiple cells may be aggregated. Unless otherwise described, the description in the present disclosure may be applied to respective serving cells.

Bandwidth Part Operation

In the case that a UE is configured with a SCG, the UE may apply the procedures according to a predefined standard for MCG and SCG (e.g., 3GPP TS 38.213).
When the procedures are applied for MCG, in the predefined standard (e.g., 3GPP TS 38.213), the terms ‘secondary cell’, ‘secondary cells’, ‘serving cell’ and ‘serving cells’ refer to secondary cell, secondary cells, serving cell and serving cells belonging to the MCG, respectively.
When the procedures are applied for SCG, in the predefined standard, the terms ‘secondary cell’, ‘secondary cells’, ‘serving cell’ and ‘serving cells’ refer to secondary cell, secondary cells not including PSCell, serving cell and serving cells belonging to the SCG, respectively. The term ‘primary cell’ refers to the PSCell of the SCG in the predefined standard (e.g., 3GPP TS 38.213).

The UE configured to operate in bandwidth parts (BWPs) of a serving cell, may be configured for the serving cell a set of at most four bandwidth parts (BWPs) for receptions by the UE (DL BWP set) in a DL bandwidth and a set of at most four BWPs for transmissions by the UE (UL BWP set) in an UL bandwidth by parameter UL-BWP for the serving cell.

An initial active DL BWP may be defined by a location and number of contiguous PRBs, a subcarrier spacing, and a cyclic prefix, for the control resource set for Type0-PDCCH common search space. For operation on the primary cell, a UE may be provided by higher layer parameter initial-UL-BWP an initial UL BWP. In the case that the UE is configured with a secondary carrier on the primary cell, the UE may be configured with an initial BWP for random access procedure on the secondary carrier.

In the case that a UE has a dedicated BWP configuration, the UE may be provided with a first active DL BWP for a reception in a primary cell by the Active-BWP-DL-Pcell and a first active UL BWP for a transmission in a primary cell by the Active-BWP-UL-Pcell.

For each DL BWP or UL BWP in a set of DL BWPs or UL BWPs, respectively, the UE may be configured with the following parameters for the serving cell as defined in a predefined standard (e.g., 3GPP TS 38.211 or 3GPP TS 38.214).
A subcarrier spacing provided by higher layer parameter DL-BWP-mu or UL-BWP-mu;
A cyclic prefix provided by higher layer parameter DL-BWP-CP or UL-BWP-CP;
A number of contiguous PRBs provided by higher layer parameter DL-BWP-BW or UL-BWP-BW, and a PRB offset for a PRB determined by higher layer parameter offset-pointA-low-scs and ref-sc;
n indexes in the set of DL BWPs or UL BWPs by respective higher layer parameters DL-BWP-index or UL-BWP-index;
A DCI format 1_0 or DCI format 1_1 detection to a PDSCH reception timing by higher layer parameter DL-data-time-domain, a PDSCH reception to a HARQ-ACK transmission timing value by higher layer parameter DL-data-DL-acknowledgement, and a DCI 0_0 or DCI 0_1 detection to a PUSCH transmission timing value by higher layer parameter UL-data-time-domain;

For an unpaired spectrum operation, in the case that the DL-BWP-index and the UL-BWP-index are identical, a DL BWP from a set of configured DL BWPs having an index provided by higher layer parameter DL-BWP-index may be paired with a UL BWP from a set of configured UL BWPs having an index provided by higher layer parameter UL-BWP-index. For unpaired spectrum operation, in the case that a DL-BWP-index of a DL BWP and a UL-BWP-index of a UL BWP are identical, a UE may not expect that the center frequency for a DL BWP is different the center frequency for a UL BWP.

For each DL BWP in a set of DL BWPs on the primary cell, a UE may be configured with control resource sets for every type of common search space and for UE-specific search space as described in a predefined standard (e.g., 3GPP TS 38.213). The UE may not be expected to be configured without a common search space on the PCell or on the PSCell, in the active DL BWP.

For each UL BWP in a set of UL BWPs, the UE is configured with resource sets for PUCCH transmissions as described in a predefined standard (e.g., 3GPP TS 38.213).

A UE may receive a PDCCH and a PDSCH in a DL BWP according to a configured subcarrier spacing and CP length for the DL BWP. The UE may transmit a PUCCH and a PUCCH in an UL BWP according to a configured subcarrier spacing and CP length for the UL BWP.

In the case that a bandwidth path indicator field is configured in DCI format 1_1, the bandwidth path indicator field value may indicate the active DL BWP, from the configured DL BWP set for DL receptions. In the case that a bandwidth path indicator field is configured in DCI format 0_1, the bandwidth path indicator field value may indicate the active UL BWP, from the configured UL BWP set for UL transmissions.

In the case that the bandwidth path indicator field is configured in DCI format 0_1 or DCI format 1_1 and represents an active UL BWP or a UL BWP different from a DL BWP or a DL BWP, respectively, a UE may operate as below.

A UE may operate as below in relation to each information field of the received DCI format 0_1 or DCI format 1_1.

In the case that a size of the information field is smaller than a UL BWP indicated by bandwidth part indicators, respectively, or that of required for DCI format 0_1 or DCI format 1_1 interpretation, a UE may have to add zero until the size becomes the size requested by the information for a UL BWP or a DL BWP before interpreting DCI format 0_1 or DCI format 1_1.

In the case that a size of the information field is smaller than a UL BWP indicated by bandwidth part indicators, respectively, or that of required for DCI format 0_1 or DCI format 1_1 interpretation, a UE may have to use the lowest bit number of DCI format 0_1 or DCI format 1_1 which is the same as that of required for a UL BWP or a DL BWP indicated by bandwidth part indicators before interpreting each of DCI format 0_1 or DCI format 1_1 information fields.
A UE may have to configure an active UL BWP indicated by bandwidth part indicators of DCI format 0_1 or DCI format 1_1 or a DL BWP with a UL BWP or a DL BWP, respectively.

Only in the case that the PDCCH is received within first three symbols of a slot, a UE may expect to detect DCI format 0_1 indicating active UL BWP change or detect DCI format 0_1 indicating active DL BWP change.

For the primary cell, a UE may be provided by higher layer parameter Default-DL-BWP a default DL BWP among the configured DL BWPs. In the case that a UE is not provided a default DL BWP by higher layer parameter Default-DL-BWP, the default BWP may be the initial active DL BWP.

In the case that a UE is configured with a higher layer parameter Default-DL-BWP indicating a default DL BWP among the configured DL BWPs for the secondary cell and configured with a higher layer parameter BWP-InactivityTimer indicating a timer value, the UE procedures in the secondary cell may be the same as the procedures in the primary cell that uses a timer value for the secondary cell and the default DL BWP.

In the case that a UE is configured with a timer value for the primary cell by the higher layer parameter BWP-InactivityTimer, and the timer is operating, and in the case that the UE is unable to detect DCI format 1_1 for paired spectrum operation during the following period or the UE unable to detect DCI format 1_1 or DCI format 0_1 for unpaired spectrum operation, the timer value may be increased in every 1 millisecond spacing for frequency range 1 or 0.5 millisecond for frequency range 2.

In the case that a UE is configured with a first active DL BWP in the secondary cell or a carrier by a higher layer parameter Active-BWP-DL-SCell or a UL BWP by a higher layer parameter Active-BWP-UP-SCell, the UE may use a DL BWP indicated by the first active DL BWP and a UL BWP indicated by the first active UL BWP, respectively, in the secondary cell or the carrier.

For paired spectrum operation, in the case that a UE changes an active UL BWP in the PCell between a time of a detection of DCI format 1_0 or DCI format 1_1 and a time of a corresponding HARQ-ACK transmission in a PUCCH, the UE may not be expected to transmit HARQ-ACK in the PUCCH resource indicated by DCI format 1_0 or DCI format 1_1.

In the case that a UE performs RRM measurement over a bandwidth that is not within the active DL BWP, the UE may not be expected to monitor a PDCCH.

A next generation wireless communication system is oriented to use wide frequency band and support various services or requirements. For example, Ultra Reliable and Low Latency Communications (URLLC), one of the representative scenarios of 3GPP New Radio (NR) requirements may require low latency and ultra-high reliability requirements of a user plane latency time of 0.5 ms and a transmission of X bytes data within 1 ms in 10⁻⁵ error rate or lower.

Furthermore, different from enhanced Mobile BroadBand (eMBB) of which traffic capacity is great, the traffic of URLLC is characterized that a file size is within dozens or hundreds of bytes and generated sporadically.

Accordingly, eMBB requires a transmission of which transmission rate is maximized and that overhead of control information is minimized. However, URLLC requires a short scheduling time unit and a reliable transmission method.

An assumption and/or a reference time unit used for transmitting and receiving a physical channel may be configured in various manners depending on an application field or a type of traffic. The reference time may be a basic unit for scheduling a specific physical channel. The reference time unit may be changed depending on the number of symbols that constitutes the corresponding scheduling unit and/or subcarrier spacing, and the like.

The present disclosure describes a reference time unit based on a slot or a mini-slot for the convenience of description. A slot may be a basic scheduling unit used for a general data traffic (e.g., eMBB), for example.

A time period of a mini-slot may be smaller than that of a slot in a time domain. The mini-slot may be a basic scheduling unit used for a traffic or communication scheme of more special purpose (e.g., URLLC, unlicensed band or millimeter wave, etc.).

However, this is just an example, the method proposed in the present disclosure may be extendedly applied to the case that a physical channel is transmitted and received based on a mini-slot for eMBB and/or a physical channel is transmitted and received based on a slot for URLLC or other communication techniques.

In the present disclosure, different PUCCH resources may mean a PUCCH resources based on different PUCCH formats or PUCCH resources in which at least one of a frequency (e.g., PRB index), a time (e.g., symbol index) and/or a code (e.g., cyclic shift (CS), OCC (orthogonal cover code) sequence) based on the same PUCCH format is allocated with different values. For example, different PUCCH formats may mean PUCCH formats in which Resource Elements to which uplink control information (UCI) and/or demodulation reference signal (DMRS) are/is mapped and/or symbol structures are different.

And/or, there is a case that uplink control information (UCI) is transmitted periodically to a PUSCH like semi-persistent (SP) channel state information (CSI) in a PUSCH, uplink control information (UCI), or uplink control information (UCI) is transmitted to a PUSCH like aperiodic (AP) channel state information (CSI) without Uplink Shared Channel (UL-SCH). Such a PUSCH transmission may be regarded as different PUCCH resources and/or PUCCH formats.

And/or, a PUCCH resource (or a resource of uplink control information, in a broader meaning) may be distinguished based on a time resource, a frequency resource, a time duration resource and/or PUSCH DM-RS mapping type for a PUSCH transmission.

In the present disclosure, a service type may be distinguished by a service requirement for downlink (or uplink) data, a TTI length, a numerology and/or a processing time. In other words, for different service types, service requirements for downlink (or uplink) data, TTI lengths, numerologies and/or processing times may be different.

In the present disclosure, a method for determining and/or configuring a PUCCH resource in which HARQ-ACK is transmitted may also be applied to a method for determining and/or configuring a PUSCH resource in which HARQ-ACK.

In a next generation system, for the purpose of supporting various service requirements and/or flexible and efficient resource use, it has been considered that HARQ-ACK transmission for a reception of a plurality of DL data of which service types and/or service requirements (e.g., eMBB or URLLC), TTI lengths, numerologies and/or processing times are different. For example, the processing time may be a timing gap between HARQ-ACK and PDSCH and/or a timing gap between PDCCH to PUSCH.

The present disclosure proposes an efficient PUCCH (or PUSCH) resource allocation and/or transmission method in the above situation.

Particularly, the present disclosure proposes a method for configuring and/or transmitting HARQ-ACK codebook in which a service type and the like are considered (hereinafter, a first embodiment), and a method for reporting and/or not reporting HARQ-ACK in a specific case (hereinafter, a second embodiment).

Hereinafter, the embodiments described in the present disclosure are distinguished only for the convenience of description, and it is understood that a certain method and/or a certain configuration of an embodiment may be substituted by a method and/or a configuration of another embodiment or applied in a mutually combined manner.

Furthermore, a slot, a subframe, a frame, and the like, mentioned in the embodiments described in the present disclosure may correspond to specific examples of predefined time units used in a wireless communication system. That is, in applying the methods proposed in the present disclosure, a time unit, and the like may also be applied by being substituted by other time units which are applied in other wireless communication systems.

### First Embodiment

First, it is described a configuration and/or transmission method of a HARQ-ACK codebook considering a service type, and the like.

Particularly, the first embodiment is described by dividing into a method for separately configuring a HARQ-ACK codebook according to a service type, and the like (hereinafter, method 1), and a method for determining a PUCCH resource according to a service type, and the like in the case that a HARQ-ACK transmission is transmitted through multiple PUCCHs (or PUCCHs) in a single slot (hereinafter, method 2), and a method for separately configuring a HARQ-ACK processing time according to a service type, and the like (hereinafter, method 3), and a method for determining a PUCCH (or PUSCH) resource according to a PDCCH (or DCI) in the case that a HARQ-ACK transmission is transmitted through multiple PUCCHs (or PUCCHs) in a single slot (hereinafter, method 4).

Hereinafter, the described methods are distinguished only for the convenience of description, and it is understood that a configuration of a certain method may be substituted by a configuration of another method or applied in a mutually combined manner.

(Method 1)

First, in the case that a HARQ-ACK transmission for multiple downlink data is transmitted through a single or multiple PUCCHs (or PUCCHs) in a single slot, it is described the method for separately configuring a HARQ-ACK codebook according to a service type, and the like, in detail.

In the case that a HARQ-ACK transmission for multiple downlink data having different service types, service requirements, TTI lengths, numerologies, and/or processing times is transmitted through a single or multiple PUCCHs (or PUCCHs) in a single slot, a rule may be defined, promised and/or configured such that a HARQ-ACK codebook is separately configured. This may also mean that HARQ-ACK (codebook) part 1 and part 2 are defined and/or supported.

For the matter of how to configure the corresponding part 1 and part 2, a base station (network) may configure the HARQ-ACKs mapped to respective part 1 and part 2 according to different service types, service requirements, TTI lengths, numerologies, and/or processing times, or the HARQ-ACKs mapped to respective part 1 and part 2 may be determined according to a certain rule. The HARQ-ACK part 1 and part 2 according to a HARQ-ACK codebook may be transmitted through a separate channel or a shared channel via separate encoding or transmitted by encoding part 1 and part 2 in jointed manner. Generally, part 1 may have higher priority to part 2, and the conditions for which part 1 and part 2 are mapped may operate differently according to each PUCCH channel or beta offset, and the like. Here, the HARQ-ACK codebook configuration may include an operation of determining the number and/or indexing of HARQ-ACK bits to be transmitted through PUCCH (or PUSCH).

For example, in the case that a semi-static codebook is configured, a HARQ-ACK codebook may be configured for each HARQ-ACK for multiple downlink data having different service types, service requirements, TTI lengths, numerologies, and/or processing times.

And/or, in the case that a dynamic codebook is configured, a counter DAI value may be separately determined for a HARQ-ACK for multiple downlink data having different service types, service requirements, TTI lengths, numerologies, and/or processing times. For total DAI, in the case that a HARQ-ACK is transmitted through a single channel in a slot, a single total DAI value may be determined, and in the case that a HARQ-ACK is transmitted through multiple channels in a slot, a total DAI value may be separately determined.

And/or, it may be separately configured for a UE whether the semi-static codebook is considered, or the dynamic codebook is considered for a HARQ-ACK for multiple downlink data having different service types, service requirements, TTI lengths, numerologies, and/or processing times. And/or, a method for configuring HARQ-ACK (codebook) part 1 and part 2 may be a set for PDSCHs for which the semi-static codebook is configured and a set for PDSCHs for which the dynamic codebook is configured, an associated set of CORESETs may be independently existed for part 1 and part 2, or an associated search space set may be separately assumed.

As an example, the semi-static codebook may be configured for eMBB HARQ-ACK, and the dynamic codebook may be configured for URLLC HARQ-ACK. This may be useful since it may be not preferable to configure a HARQ-ACK feedback bit by considering a HARQ-ACK bit for URLLC downlink data always when a traffic of URLLC is sporadically generated and assumed that the traffic is not generated relatively frequently. And/or the dynamic codebook may be configured for eMBB HARQ-ACK, and the semi-static codebook may be configured for URLLC HARQ-ACK.

And/or, different codebooks may be configured for the PDSCH of which processing time is a predetermined value or greater and the PDSCH of which processing time is a predetermined value or smaller, respectively (or processing times are grouped and for each duration).

And/or, the HARQ-ACKs mapped to HARQ-ACK (codebook) part 1 and part 2 may include the HARQ-ACKs that correspond to a PDSCH scheduled by a PDCCH which is transmitted in CORESET #x and #y, respectively, and the semi-static or dynamic codebook may be configured for each CORESET, or part 1 and part 2 may be configured. And the semi-static codebook may be presumed for part 1 and the dynamic codebook may be presumed for part 2. According to a configuration, it is available that all the HARQ-ACKs may be mapped to part 1 or part 2. Also, it may be assumed that a HARQ-ACK bit is configured for each HARQ-ACK part and transmitted according to part 1 and part 2 transmission schemes.

And/or, a separate HARQ-ACK bundling may be configured, or promised in advance, defined, and/or configured for a HARQ-ACK for multiple downlink data having different service types, service requirements, TTI lengths, numerologies, and/or processing times.

Distinctively, in the case that HARQ-ACKs for multiple downlink data having different service types, service requirements, TTI lengths, numerologies, and/or processing times are transmitted together in a single channel, for a HARQ-ACK for a specific service type, a service requirement, a TTI length, a numerology, and/or a processing time, a rule may be defined, promised, and/or configured such that a spatial, carrier-domain, and/or time-domain bundling is applied. For example, a rule may be defined, promised, and/or configured such that a bundling is applied for the HARQ-ACK for eMBB (or having a strict BLER requirement less than 10^{-x}) PDSCH.

And/or, a rule may be defined, promised, and/or configured such that a bundling is applied for the HARQ-ACK for PDSCHs which are configured and/or indicated so as to use a specific Modulation and Coding Scheme (MCS) table. And/or, it may be configured to a UE whether a bundling is applied for each service type, service requirement, TTI length, numerology, and/or processing time through a higher layer signaling independently.

And/or, in the above description, a service type and/or a service requirement may be configured through a higher layer signaling, or indicated explicitly through downlink control information (DCI) that schedules downlink data, or distinguished through a search space to which the PDCCH scheduling downlink data is belonged, a control resource set (CORESET) to which the PDCCH scheduling downlink data is belonged, RNTI, DCI format, and/or CRC masking of PDCCH. In addition, in the case that a service type and/or a service requirement are not explicitly distinguished, the “HARQ-ACK for multiple downlink data having different service types and/or service requirements” may be substituted by the “HARQ-ACK for multiple downlink data scheduled through different search space, different CORESET, different RNTI, different DCI format, and/or CRC masking of different PDCCH”, and the proposals may be applied.

In the case that HARQ-ACK (codebook) is divided into part 1 and part 2, an example of the attributes for part 1 and part 2 may be as below.

1) Part 1 and Part 2 configure codebook generation schemes differently. Part 1 and Part 2 may include bits according to a semi-static codebook and a dynamic codebook, respectively.

2) Part 1 and Part 2 may be divided into fixed sizes and variable sizes. A size of part 1 may be fixed or uses a known value between a base station and a UE, and a size of part 2 may be variable and uses different size according to Quality of Service (QoS) requirement of a UE or current Signal to Interference & Noise Ratio (SINR) and/or Channel State information (CSI), and the like, or changed according to a network configuration (dynamic or static). For example, a final bit number for part 2 may be determined by being decreased from a bit number determined according to a semi-static codebook and/or a dynamic codebook as necessary or according to a predefined rule. The size of part 2 may also be transmitted with being included in part 1.

And/or, a mapping scheme of part 1 and part 2 may consider the followings.

1) Part 1 may always be transmitted, and part 2 may be transmitted only in the case of a PUSCH with a best effort.

2) Part 1 may always be transmitted, and part 2 may be transmitted with a code rate in accordance with a remaining Resource Element (RE).

(Method 2)

Next, in the case that a HARQ-ACK transmission is transmitted through multiple PUCCHs (or PUSCHs) in a slot, a method for determining a PUCCH resource according to a service type, and the like is described in detail.

In the case that a HARQ-ACK transmission for multiple downlink data having different service types, service requirements, TTI lengths, numerologies, and/or processing times is transmitted through multiple PUCCHs (or PUSCHs) in a single slot, a PUCCH including each HARQ-ACK bit may be determined considering below.

Even in the case that HARQ-ACK transmission timings of eMBB HARQ-ACK and URLLC HARQ-ACK are the same slot, a rule may be defined, promised, and/or configured to be transmitted to different PUCCHs (or PUSCHs) in the corresponding slot.

And/or, it may be determined a channel to which the HARQ-ACK for the corresponding PDSCH is transmitted among the multiple PUCCHs (or PUSCHs) in a single slot according to configured and/or indicated MCS table.

And/or, for a PDSCH of which processing time is a predetermined value or greater and a PDSCH of which processing time is a predetermined value or smaller (or a grouping for processing times is preconfigured by a promise or configured and/or indicated through a higher layer signal and/or a physical layer signal and for each group), it may be determined a channel to which the HARQ-ACK for the corresponding PDSCH is transmitted among the multiple PUCCHs (or PUSCHs) in a single slot. For example, for the PDSCH, for the PDSCHs of which timing gap up to HARQ-ACK are 8, 7, 6 and 5 slots, the HARQ-ACK may be transmitted in PUCCH resource 1, and for the PDSCHs of which timing gap up to HARQ-ACK are 4, 3, 2 and 1 slots, the HARQ-ACK may be transmitted in PUCCH resource 2.

And/or, candidates of processing times for each group may be preconfigured by a promise, or candidates of processing times for each group may be configured and/or indicated through a higher layer signal and/or a physical layer signal, and based on it, a HARQ-ACK codebook may be configured for each group. At this time, the number of groups in a slot may be predefined as a fixed value or may be configured and/or indicated through a higher layer signal and/or a physical layer signal. And/or, a Downlink Assignment Index (DAI) for each of the groups may be separately defined, and this may mean that a DL association set to be referred when a HARQ-ACK codebook is generated and/or configured for each group may be separately determined.

And/or, for each of the groups, a PUCCH resource interlinked with a specific state of a PUCCH resource indicator may be separately configured. And/or, it may be explicitly indicated (e.g., group index) a group to which the HARQ-ACK for the corresponding PDSCH is belonged by a specific field of the DCI that schedules the PDSCH. Distinctively, the group index may be newly defined or indicated by using a part of (or the whole) bit of a timing indicator field up to HARQ feedback in a PDSCH of the existing 3 bits. In the case that two groups are configured and/or defined, for example, in the two bits of PDSCH, the timing indicator and 1 bit group index up to HARQ feedback may be used for interpretation.

And/or, total HARQ-ACK bits in a slot determined based on a processing time may be distributed for each PUCCH resource in the corresponding slot. For example, in the case that four PUCCHs are transmitted in a slot, the total HARQ-ACK bits may be divided into four groups and transmitted to each PUCCH. For example, in the case that the total HARQ-ACK bits are 12 bits, the HARQ-ACK bits are divided into 3, 3, 3, 3 bits, and in the case that the total HARQ-ACK bits are 10 bits, the HARQ-ACK bits are divided into 3, 3, 2, 2 bits or 3, 3, 3, 1 bits in an equal manner to the maximum.

And/or, the processing time is divided into four groups, and the corresponding the HARQ-ACK bits may be transmitted to each PUCCH. For example, the PDSCHs of which timing gaps from the PDSCH to the HARQ-ACK is 8, 7 slots may transmit the HARQ-ACK with PUCCH resource 1, the PDSCHs of which timing gaps from the PDSCH to the HARQ-ACK is 6, 5 slots may transmit the HARQ-ACK with PUCCH resource 2, the PDSCHs of which timing gaps from the PDSCH to the HARQ-ACK is 4, 3 slots may transmit the HARQ-ACK with PUCCH resource 3, and the PDSCHs of which timing gaps from the PDSCH to the HARQ-ACK is 2, 1 slots may transmit the HARQ-ACK with PUCCH resource 4.

And/or, through the PDSCH that has less strict Block Error Rate (BLER) requirement than 10^{-x}, HARQ-ACK may be transmitted to PUCCH resource 1, and through the PDSCH that has stricter BLER than 10^{-x}, HARQ-ACK may be transmitted to PUCCH resource 2.

And/or, a slot may be configured with a Transmission Time Interval (TTI) that has a plurality of small time units (virtually) by the number which is predefined, configured through a higher layer signal and/or indicated through a physical layer signal, and a separate HARQ-ACK codebook may be configured for each TTI. For example, in the case that it is configured and/or indicated that a slot includes two mini-slots, the HARQ-ACK that corresponds to a PDSCH transmitted in the first mini-slot in each slot may be considered as the HARQ-ACK bit of a PUCCH transmitted in the first mini-slot in the PUCCH transport slot indicated by the processing time, and the HARQ-ACK that corresponds to a PDSCH transmitted in the second mini-slot may be considered as the HARQ-ACK bit of a PUCCH transmitted in the second mini-slot in the PUCCH transport slot indicated by the processing time.

The service type and/or the service requirement may be configured through a higher layer signaling, or indicated explicitly through downlink control information (DCI) that schedules downlink data, or distinguished through a search space to which the PDCCH scheduling downlink data is belonged, a control resource set (CORESET) to which the PDCCH scheduling downlink data is belonged, RNTI, DCI format, and/or CRC masking of PDCCH. In addition, in the case that a service type and/or a service requirement are not explicitly distinguished, the “HARQ-ACK for multiple downlink data having different service types and/or service requirements” may be substituted by the “HARQ-ACK for multiple downlink data scheduled through different search space, different CORESET, different RNTI, different DCI format, and/or CRC masking of different PDCCH”, and the proposals may be applied.

(Method 3)

Next, it is described a method for configuring a HARQ-ACK processing time separately according to a service type, and the like in detail.

A rule may be defined, promised and/or configured such that a set of processing times (e.g., timing gap from a PDSCH to a HARQ-ACK) k1 may be configured through a higher layer separately for different service types and/or service requirements. And/or, a rule may be defined, promised and/or configured such that a time-domain resource allocation table is configured through a higher layer independently for different service types, service requirements and/or processing times. And/or, a single time-domain resource allocation table may be configured without regard to a service type, a service requirement and/or a processing time.

The service type and/or the service requirement may be configured through a higher layer signaling, or indicated explicitly through downlink control information (DCI) that schedules downlink data, or distinguished through a search space to which the PDCCH scheduling downlink data is belonged, a control resource set (CORESET) to which the PDCCH scheduling downlink data is belonged, RNTI, DCI format, and/or CRC masking of PDCCH. In addition, in the case that a service type and/or a service requirement are not explicitly distinguished, the “HARQ-ACK for multiple downlink data having different service types and/or service requirements” may be substituted by the “HARQ-ACK for multiple downlink data scheduled through different search space, different CORESET, different RNTI, different DCI format, and/or CRC masking of different PDCCH”, and the proposals may be applied.

(Method 4)

Next, in the case that a HARQ-ACK transmission is transmitted through multiple PUCCSs (or PUSCHs) in a slot, a method for determining a PUCCH (or PUSCH) resource according to a PDCCH (or DCI) is described in detail.

In the case that a HARQ-ACK transmission for multiple downlink data is transmitted through multiple PUCCHs (or PUCCHs) in a slot, a PUCCH resource may be determined and/or configured as below.

A plurality of resources (or resource subsets) is interlinked to a state indicated by “PUCCH resource indicator” and configured for a UE, and a rule may be defined, promised, and/or configured such that a PUCCH resource is to be used finally for the HARQ-ACK transmission for the corresponding PDSCH according to a service type and/or service requirement (e.g., eMBB or URLLC) for a PDSCH, a processing time, a search space, a CORESET, a DCI format, an RNTI, a CRC masking of PDCCH and/or a value indicated by a specific field in downlink control information (DCI) (except the “PUCCH resource indicator”).

And/or, a rule may be defined, promised, and/or configured such that different resource set is used for the HARQ-ACK transmission for the corresponding PDSCH according to a service type and/or service requirement (e.g., eMBB or URLLC) for a PDSCH, a processing time, a search space, a CORESET, a DCI format, an RNTI, a CRC masking of PDCCH and/or a value indicated by a specific field in DCI (except the “PUCCH resource indicator”). Alternatively, a rule may be defined, promised, and/or configured such that a resource set is determined by considering a service type and/or service requirement (e.g., eMBB or URLLC), a processing time, a search space, a CORESET, a DCI format, an RNTI, a CRC masking of PDCCH and/or a value indicated by a specific field in DCI (except the “PUCCH resource indicator”) except a payload size of PUCCH.

And/or, when a PUCCH resource is configured, a plurality of starting symbols and lengths may be configured (or a single starting symbol and length and a plurality of offsets may be configured), and from these, a time domain PUCCH resource corresponding to a multiple PUCCHs may be determined in a slot. According to a service type and/or service requirement (e.g., eMBB or URLLC) for a PDSCH, a processing time, a search space, a CORESET, a DCI format, an RNTI, a CRC masking of PDCCH and/or a value indicated by a specific field in DCI (except the “PUCCH resource indicator”), it may be determined a PUCCH resource through which the HARQ-ACK for the corresponding PDSCH is transmitted among multiple PUCCHs in a slot.

A processing time for a specific service type and/or a service requirement (e.g., URLLC) may be represented finer unit than a time unit (e.g., slot) of the existing processing time. For example, the processing time for a specific service type and/or a service requirement (e.g., URLLC) may be configured in a symbol unit or a slot+symbol unit.

In this case, a length of symbol may be determined by a default numerology (e.g., 15 kHz or based on a preconfigured numerology), a numerology of PDCCH and/or PDSCH, or a numerology of PUCCH and/or PUSCH.

### Second Embodiment

Next, in a specific case, a method of not reporting a HARQ-ACK is described in detail.

For downlink data having a specific service type and/or a service requirement (e.g., URLLC), to which a specific processing time is configured, and/or corresponding to a specific search space, a specific CORESET, a specific DCI format, a specific RNTI, a specific CRC masking of PDCCH and/or a value indicated by a specific field in DCI, a rule may be defined, promised, and/or configured such that a UE does not report a HARQ-ACK. Here, the operation of not reporting a HARQ-ACK may mean not it is not included in a bit number calculating when a HARQ-ACK codebook is configured.

The service type and/or the service requirement may be configured through a higher layer signaling, or indicated explicitly through downlink control information (DCI) that schedules downlink data, or distinguished through a search space to which the PDCCH scheduling downlink data is belonged, a control resource set (CORESET) to which the PDCCH scheduling downlink data is belonged, RNTI, DCI format, and/or CRC masking of PDCCH. In addition, in the case that a service type and/or a service requirement are not explicitly distinguished, the “HARQ-ACK for multiple downlink data having different service types and/or service requirements” may be substituted by the “HARQ-ACK for multiple downlink data scheduled through different search space, different CORESET, different RNTI, different DCI format, and/or CRC masking of different PDCCH”, and the proposals may be applied.

And/or, in the case that an operation of not reporting a HARQ-ACK for specific downlink data is indicated for the case that the dynamic codebook is configured, the following method may be considered. The DAI corresponding to the downlink data in which a HARQ-ACK is not reported may be disregarded. That is, when a UE configure a HARQ-ACK codebook, in calculating a bit number, the UE may disregard the DAI field in a PDCCH that schedules the corresponding downlink data.

Since the examples of the method proposed in the present disclosure described above may be included as one of the implementation methods of the present disclosure, it is apparent that the examples of the method proposed in the present disclosure described above may be regarded as a kind of proposed methods. In addition, the proposed methods described above may be implemented independently, but may also be implemented in a combination (or merger) of a part of proposed methods. A rule may be defined such that information on whether the proposed methods are applied (or information for the rules of the proposed methods) may be informed by a base station through a predefined signal (e.g., physical layer signal or higher layer signal) to a UE.

FIG. 10 is a flowchart for describing an operation method of a UE proposed in the present disclosure.

Referring to FIG. 10, first, a UE may receive a Physical Downlink Shared Channel (PDSCH) from a base station (step, S1001).

The PDSCH may include a first PDSCH related to a first service type and a second PDSCH related to a second service type.

Here, the service type may be distinguished by a service requirement, a Transmission Time Interval (TTI) length, a numerology and/or a processing time. In other words, the first PDSCH related to the first service type may be a PDSCH that has different Transmission Time Unit, numerology and/or processing time from the second PDSCH related to the second service type. In the present disclosure, a transmission time interval may be used as the same meaning of a transmission time unit.

In a particular example, the first service type may be a service type that requires ultra-high reliability and very low latency, and the second service type may be a service type that has a requirement of fast transmission of many data. In other words, the first PDSCH related to the first service type may be a PDSCH that includes Ultra-Reliable and Low Latency Communications (URLLC) data, and the second PDSCH related to the second service type may be a PDSCH that includes enhanced Mobile BroadBand (eMBB) data.

The first service type and the second service type may be identified, distinguished and/or determined by a format of Downlink Control Information (DCI) that schedules the corresponding PDSCH, service type information included in the DCI, a Radio Network Temporary Identifier (RNTI) which is Cyclic Redundancy Check (CRC)-scrambled to the DCI, a Control Resource Set (CORESET) received in the DCI, CRC masking of DCI and/or a search space in which the DCI is monitored. In other words, each of the service types of PDSCHs may be indicated, defined, and/or configured explicitly or implicitly by DCI. Here, the service type information may be information that represents a service type for the PDSCH which is scheduled by DCI.

Next, the UE may transmit an Uplink Physical Channel including Hybrid Automatic Repeat request (HARQ)-Acknowledgement (ACK) information for the PDSCH to the base station (step, S1002). Here, the Uplink Physical Channel may include a Physical Uplink Control Channel (PUCCH) or a Physical Uplink Shared Channel (PUSCH).

Distinctively, the HARQ-ACK information for the first PDSCH may be included in a HARQ-ACK codebook which is different from a HARQ-ACK codebook including the HARQ-ACK information for the second PDSCH. In other words, the data (e.g., URLLC data) related to the first service type may be transmitted to the base station with being included in a codebook different from the HARQ-ACK codebook including the HARQ-ACK information for the data (e.g., eMBB data) related to the second service type. For example, the HARQ-ACK information related to the data related to the first service type and the HARQ-ACK information related to the data related to the second service type may be indexed by different pseudo-codes and configure separate codebooks. In addition, the HARQ-ACK information related to the data related to the first service type and the HARQ-ACK information related to the data related to the second service type may be separately coded, and in the case that the dynamic codebook is configured, a Downlink Assignment Index (DAI) may be separately counted.

At this time, the HARQ-ACK codebook for the first PDSCH and the HARQ-ACK codebook for the second PDSCH may be transmitted through a single Uplink Physical Channel (e.g., a single PUCCH or a single PUSCH) in the same slot or may be transmitted different Uplink Physical Channels.

And/or, the UE may receive a higher layer signal including a set of PDSCH processing times related to each of the service types. In other words, the higher layer signal may include a plurality of processing times (set) of the first PDSCH related to the first service type and a plurality of processing times (set) of the second PDSCH related to the second service type. Here, the PDSCH processing time may be an offset (e.g., k1) from a PDSCH reception to a HARQ-ACK transmission. And/or, the processing time may mean a time required for calculating the HARQ-ACK information for the corresponding PDSCH. In addition, the PDSCH processing time may be defined, promised and/or configured with various transmission time unit such as the number of slots, the number of sub-slots, and/or the number of symbols.

And/or, the UE may determine and/or identify a specific processing time among a plurality of processing times related to each of the service types by a format of Downlink Control Information (DCI) that schedules the PDSCH, processing time information included in the DCI, a Radio Network Temporary Identifier (RNTI) which is Cyclic Redundancy Check (CRC)-scram bled to the DCI, a Control Resource Set (CORESET) in which the DCI is received, CRC masking of DCI and/or a search space in which the DCI is monitored. Here, processing time information may be information indicating or representing a specific processing time among a plurality of processing times related to each of the service types. Alternatively, the UE may determine and/or identify a specific processing time among a plurality of processing times related to each of the service types by a higher layer signal.

The UE may determine a processing time related to each service type by a higher layer signal and/or specific information (e.g., DCI) and based on the determined processing time, transmit the HARQ-ACK information for the corresponding PDSCH to the base station.

And/or, the UE may receive configuration information for performing a transmission/reception in a sub-slot unit from the base station. The configuration information may be information that configures a Transmission Time Unit with sub-slots in a slot. In addition, the configuration information may be included in a higher layer signal or a physical layer signal.

In the case that the UE receives the configuration information, the UE may perform a reception, decoding, and/or processing of a downlink physical channel in a sub-slot unit and perform a reception, decoding, and/or processing of an uplink physical channel in a sub-slot unit.

For example, the first PDSCH may include PDSCHs in which HARQ-ACK transmission slot is indicated by a specific slot among PDSCHs received in a first sub-slot of each slot, the second PDSCH may include PDSCHs in which HARQ-ACK transmission slot is indicated by the specific slot among PDSCHs received in a second sub-slot of each slot, the Uplink Physical Channel may include a first Uplink Physical Channel transmitted in the first sub-slot of the specific slot and a second Uplink Physical Channel transmitted in the second sub-slot of the specific slot, and the first Uplink Physical Channel may include the HARQ-ACK information for the first PDSCH, and the second Uplink Physical Channel may include the HARQ-ACK information for the second PDSCH. Here, the fact that the HARQ-ACK transmission slot is indicated by a specific slot may mean that a HARQ-ACK transmission timing (or processing time) of the corresponding PDSCH is determined and/or configured with a specific slot.

As another example, the first PDSCH may be received in a first slot and the second PDSCH may be received in a second slot. At this time, the Uplink Physical Channel may include a first Uplink Physical Channel transmitted in a third sub-slot in a specific slot and a second Uplink Physical Channel transmitted in a fourth sub-slot in a specific slot, the first Uplink Physical Channel may include the HARQ-ACK information for the first PDSCH and the second Uplink Physical Channel may include the HARQ-ACK information for the second PDSCH. In other words, in the same slot, the UE may transmit the first Uplink Physical Channel including the HARQ-ACK information for the first PDSCH in the first sub-slot and the second Uplink Physical Channel including the HARQ-ACK information for the second PDSCH in the second sub-slot. At this time, a timing offset between the first sub-slot and the third sub-slot and/or a timing offset between the second sub-slot and the fourth sub-slot may be transmitted with the number of sub-slots (or the number of slots, the number of symbols) through a higher layer signal or a physical layer signal, or determined and/or configured according to a processing time of the PDSCH (the first PDSCH or the second PDSCH), and/or the service property of the PDSCH. In other words, the timing offset may be determined and/or configured differently for each PDSCH which is received in each sub-slot.

And/or, the first sub-slot and the second sub-slot may be included in the same slot which is different from the specific slot (the slot including the third sub-slot and the fourth sub-slot). At this time, a timing offset (or PDSCH processing time) between the slot including the first sub-slot and the second sub-slot and the slot including the third sub-slot and the fourth sub-slot may be transmitted through a higher layer signal or a physical layer signal (e.g., DCI) with the number of sub-slots (or the number of slots, the number of symbols) or determined and/or configured according to the processing time of the PDSCH (the first PDSCH or the second PDSCH), and/or the service type of the PDSCH.

Here, the first Uplink Physical Channel and the second Uplink Physical Channel may mean a PUCCH based on different PUCCH formats or a PUCCH to which at least one of a frequency based on the same PUCCH format (e.g., PRB index), a time (e.g., symbol index), and/or a code (e.g., cyclic shift, orthogonal cover code sequence) is configured as different value. For example, different PUCCH formats may be PUCCH formats of which Resource Element (RE) to which uplink control information (UCI) and/or demodulation reference signal (DMRS) is mapped and/or symbol structure is different.

And/or, in the case that UCI is transmitted through a Physical Uplink Shared Channel (PUSCH), a PUSCH transmission may also be regarded as different PUCCHs and/or PUCCH formats.

And/or, a PUCCH may be distinguished based on a time resource configured for a PUSCH transmission, a frequency resource, a duration time, and/or a PUSCH DM-RS mapping type.

The operation method of the UE shown in FIG. 10 is the same as the operation method of the UE described referring to FIG. 1 to FIG. 9, and the detailed description is omitted.

In relation to this, the operation of the UE described above may be implemented particularly by the UE 1220 shown in FIG. 12. For example, the operation of the UE described above may be performed by a processor 1221 and/or an RF unit 1223.

Referring to FIG. 12, first, the processor 1221 may receive a Physical Downlink Shared Channel (PDSCH) from a base station via the RF unit 1223 (step, S1001).

The PDSCH may include a first PDSCH related to a first service type and a second PDSCH related to a second service type.

Here, the service type may be distinguished by a service requirement, a Transmission Time Interval (TTI) length, a numerology and/or a processing time. In other words, the first PDSCH related to the first service type may be a PDSCH that has different Transmission Time Unit, numerology and/or processing time from the second PDSCH related to the second service type. In the present disclosure, a transmission time interval may be used as the same meaning of a transmission time unit.

In a particular example, the first service type may be a service type that requires ultra-high reliability and very low latency, and the second service type may be a service type that has a requirement of fast transmission of many data. In other words, the first PDSCH related to the first service type may be a PDSCH that includes Ultra-Reliable and Low Latency Communications (URLLC) data, and the second PDSCH related to the second service type may be a PDSCH that includes enhanced Mobile BroadBand (eMBB) data.

The first service type and the second service type may be identified, distinguished and/or determined by a format of Downlink Control Information (DCI) that schedules the corresponding PDSCH, service type information included in the DCI, a Radio Network Temporary Identifier (RNTI) which is Cyclic Redundancy Check (CRC)-scrambled to the DCI, a Control Resource Set (CORESET) received in the DCI, CRC masking of DCI and/or a search space in which the DCI is monitored. In other words, each of the service types of PDSCHs may be indicated, defined, and/or configured explicitly or implicitly by DCI. Here, the service type information may be information that represents a service type for the PDSCH which is scheduled by DCI.

Next, the processor 1221 may transmit an Uplink Physical Channel including Hybrid Automatic Repeat request (HARQ)-Acknowledgement (ACK) information for the PDSCH to the base station via the RF unit 1223 (step, S1002). Here, the Uplink Physical Channel may include a Physical Uplink Control Channel (PUCCH) or a Physical Uplink Shared Channel (PUSCH).

Distinctively, the HARQ-ACK information for the first PDSCH may be included in a HARQ-ACK codebook which is different from a HARQ-ACK codebook including the HARQ-ACK information for the second PDSCH. In other words, the data (e.g., URLLC data) related to the first service type may be transmitted to the base station with being included in a codebook different from the HARQ-ACK codebook including the HARQ-ACK information for the data (e.g., eMBB data) related to the second service type. For example, the HARQ-ACK information related to the data related to the first service type and the HARQ-ACK information related to the data related to the second service type may be indexed by different pseudo-codes and configure separate codebooks. In addition, the HARQ-ACK information related to the data related to the first service type and the HARQ-ACK information related to the data related to the second service type may be separately coded, and in the case that the dynamic codebook is configured, a Downlink Assignment Index (DAI) may be separately counted.

At this time, the HARQ-ACK codebook for the first PDSCH and the HARQ-ACK codebook for the second PDSCH may be transmitted through a single Uplink Physical Channel (e.g., a single PUCCH or a single PUSCH) in the same slot or may be transmitted different Uplink Physical Channels.

And/or, the UE may receive a higher layer signal including a set of PDSCH processing times related to each of the service types. In other words, the higher layer signal may include a plurality of processing times (set) of the first PDSCH related to the first service type and a plurality of processing times (set) of the second PDSCH related to the second service type. Here, the PDSCH processing time may be an offset (e.g., k1) from a PDSCH reception to a HARQ-ACK transmission. And/or, the processing time may mean a time required for calculating the HARQ-ACK information for the corresponding PDSCH. In addition, the PDSCH processing time may be defined, promised and/or configured with various transmission time unit such as the number of slots, the number of sub-slots, and/or the number of symbols.

And/or, the UE may determine and/or identify a specific processing time among a plurality of processing times related to each of the service types by a format of Downlink Control Information (DCI) that schedules the PDSCH, processing time information included in the DCI, a Radio Network Temporary Identifier (RNTI) which is Cyclic Redundancy Check (CRC)-scrambled to the DCI, a Control Resource Set (CORESET) in which the DCI is received, CRC masking of DCI and/or a search space in which the DCI is monitored. Here, processing time information may be information indicating or representing a specific processing time among a plurality of processing times related to each of the service types. Alternatively, the UE may determine and/or identify a specific processing time among a plurality of processing times related to each of the service types by a higher layer signal.

The UE may determine a processing time related to each service type by a higher layer signal and/or specific information (e.g., DCI) and based on the determined processing time, transmit the HARQ-ACK information for the corresponding PDSCH to the base station.

And/or, the UE may receive configuration information for performing a transmission/reception in a sub-slot unit from the base station. The configuration information may be information that configures a Transmission Time Unit with sub-slots in a slot. In addition, the configuration information may be included in a higher layer signal or a physical layer signal.

In the case that the UE receives the configuration information, the UE may perform a reception, decoding, and/or processing of a downlink physical channel in a sub-slot unit and perform a reception, decoding, and/or processing of an uplink physical channel in a sub-slot unit.

For example, the first PDSCH may include PDSCHs in which HARQ-ACK transmission slot is indicated by a specific slot among PDSCHs received in a first sub-slot of each slot, the second PDSCH may include PDSCHs in which HARQ-ACK transmission slot is indicated by the specific slot among PDSCHs received in a second sub-slot of each slot, the Uplink Physical Channel may include a first Uplink Physical Channel transmitted in the first sub-slot of the specific slot and a second Uplink Physical Channel transmitted in the second sub-slot of the specific slot, and the first Uplink Physical Channel may include the HARQ-ACK information for the first PDSCH, and the second Uplink Physical Channel may include the HARQ-ACK information for the second PDSCH. Here, the fact that the HARQ-ACK transmission slot is indicated by a specific slot may mean that a HARQ-ACK transmission timing (or processing time) of the corresponding PDSCH is determined and/or configured with a specific slot.

As another example, the first PDSCH may be received in a first slot and the second PDSCH may be received in a second slot. At this time, the Uplink Physical Channel may include a first Uplink Physical Channel transmitted in a third sub-slot in a specific slot and a second Uplink Physical Channel transmitted in a fourth sub-slot in a specific slot, the first Uplink Physical Channel may include the HARQ-ACK information for the first PDSCH and the second Uplink Physical Channel may include the HARQ-ACK information for the second PDSCH. In other words, in the same slot, the UE may transmit the first Uplink Physical Channel including the HARQ-ACK information for the first PDSCH in the first sub-slot and the second Uplink Physical Channel including the HARQ-ACK information for the second PDSCH in the second sub-slot. At this time, a timing offset between the first sub-slot and the third sub-slot and/or a timing offset between the second sub-slot and the fourth sub-slot may be transmitted with the number of sub-slots (or the number of slots, the number of symbols) through a higher layer signal or a physical layer signal or determined and/or configured according to a processing time of the PDSCH (the first PDSCH or the second PDSCH), and/or the service property of the PDSCH. In other words, the timing offset may be determined and/or configured differently for each PDSCH which is received in each sub-slot.

And/or, the first sub-slot and the second sub-slot may be included in the same slot which is different from the specific slot (the slot including the third sub-slot and the fourth sub-slot). At this time, a timing offset (or PDSCH processing time) between the slot including the first sub-slot and the second sub-slot and the slot including the third sub-slot and the fourth sub-slot may be transmitted through a higher layer signal or a physical layer signal (e.g., DCI) with the number of sub-slots (or the number of slots, the number of symbols) or determined and/or configured according to the processing time of the PDSCH (the first PDSCH or the second PDSCH), and/or the service type of the PDSCH.

Here, the first Uplink Physical Channel and the second Uplink Physical Channel may mean a PUCCH based on different PUCCH formats or a PUCCH to which at least one of a frequency based on the same PUCCH format (e.g., PRB index), a time (e.g., symbol index), and/or a code (e.g., cyclic shift, orthogonal cover code sequence) is configured as different value. For example, different PUCCH formats may be PUCCH formats of which Resource Element (RE) to which uplink control information (UCI) and/or demodulation reference signal (DMRS) is mapped and/or symbol structure is different.

And/or, in the case that UCI is transmitted through a Physical Uplink Shared Channel (PUSCH), a PUSCH transmission may also be regarded as different PUCCHs and/or PUCCH formats.

And/or, a PUCCH may be distinguished based on a time resource configured for a PUSCH transmission, a frequency resource, a duration time, and/or a PUSCH DM-RS mapping type.

The operation method of the UE shown in FIG. 12 is the same as the operation method of the UE described referring to FIG. 1 to FIG. 9, and the detailed description is omitted.

FIG. 11 is a flowchart for describing an operation method of a base station proposed in the present disclosure.

Referring to FIG. 11, first, a base station may transmit a Physical Downlink Shared Channel (PDSCH) to a UE (step, S1101).

The PDSCH may include a first PDSCH related to a first service type and a second PDSCH related to a second service type.

Here, the service type may be distinguished by a service requirement, a Transmission Time Interval (TTI) length, a numerology and/or a processing time. In other words, the first PDSCH related to the first service type may be a PDSCH that has different Transmission Time Unit, numerology and/or processing time from the second PDSCH related to the second service type. In the present disclosure, a transmission time interval may be used as the same meaning of a transmission time unit.

In a particular example, the first service type may be a service type that requires ultra-high reliability and very low latency, and the second service type may be a service type that has a requirement of fast transmission of many data. In other words, the first PDSCH related to the first service type may be a PDSCH that includes Ultra-Reliable and Low Latency Communications (URLLC) data, and the second PDSCH related to the second service type may be a PDSCH that includes enhanced Mobile BroadBand (eMBB) data.

The first service type and the second service type may be identified, distinguished and/or determined by a format of Downlink Control Information (DCI) that schedules the corresponding PDSCH, service type information included in the DCI, a Radio Network Temporary Identifier (RNTI) which is Cyclic Redundancy Check (CRC)-scrambled to the DCI, a Control Resource Set (CORESET) received in the DCI, CRC masking of DCI and/or a search space in which the DCI is monitored. In other words, each of the service types of PDSCHs may be indicated, defined, and/or configured explicitly or implicitly by DCI. Here, the service type information may be information that represents a service type for the PDSCH which is scheduled by DCI.

Next, the base station may receive an Uplink Physical Channel including Hybrid Automatic Repeat request (HARQ)-Acknowledgement (ACK) information for the PDSCH from the UE (step, S1102). Here, the Uplink Physical Channel may include a Physical Uplink Control Channel (PUCCH) or a Physical Uplink Shared Channel (PUSCH).

Distinctively, the HARQ-ACK information for the first PDSCH may be included in a HARQ-ACK codebook which is different from a HARQ-ACK codebook including the HARQ-ACK information for the second PDSCH. In other words, the data (e.g., URLLC data) related to the first service type may be transmitted to the base station with being included in a codebook different from the HARQ-ACK codebook including the HARQ-ACK information for the data (e.g., eMBB data) related to the second service type. For example, the HARQ-ACK information related to the data related to the first service type and the HARQ-ACK information related to the data related to the second service type may be indexed by different pseudo-codes and configure separate codebooks. In addition, the HARQ-ACK information related to the data related to the first service type and the HARQ-ACK information related to the data related to the second service type may be separately coded, and in the case that the dynamic codebook is configured, a Downlink Assignment Index (DAI) may be separately counted.

At this time, the HARQ-ACK codebook for the first PDSCH and the HARQ-ACK codebook for the second PDSCH may be transmitted through a single Uplink Physical Channel (e.g., a single PUCCH or a single PUSCH) in the same slot or may be transmitted different Uplink Physical Channels.

And/or, the base station may transmit a higher layer signal including a set of PDSCH processing times related to each of the service types. In other words, the higher layer signal may include a plurality of processing times (set) of the first PDSCH related to the first service type and a plurality of processing times (set) of the second PDSCH related to the second service type. Here, the PDSCH processing time may be an offset (e.g., k1) from a PDSCH reception to a HARQ-ACK transmission. And/or, the processing time may mean a time required for calculating the HARQ-ACK information for the corresponding PDSCH. In addition, the PDSCH processing time may be defined, promised and/or configured with various transmission time unit such as the number of slots, the number of sub-slots, and/or the number of symbols.

And/or, the UE may determine and/or identify a specific processing time among a plurality of processing times related to each of the service types by a format of Downlink Control Information (DCI) that schedules the PDSCH, processing time information included in the DCI, a Radio Network Temporary Identifier (RNTI) which is Cyclic Redundancy Check (CRC)-scram bled to the DCI, a Control Resource Set (CORESET) in which the DCI is received, CRC masking of DCI and/or a search space in which the DCI is monitored. Here, processing time information may be information indicating or representing a specific processing time among a plurality of processing times related to each of the service types. Alternatively, the UE may determine and/or identify a specific processing time among a plurality of processing times related to each of the service types by a higher layer signal.

The UE may determine a processing time related to each service type by a higher layer signal and/or specific information (e.g., DCI) and based on the determined processing time, transmit the HARQ-ACK information for the corresponding PDSCH to the base station.

And/or, the UE may receive configuration information for performing a transmission/reception in a sub-slot unit from the base station. The configuration information may be information that configures a Transmission Time Unit with sub-slots in a slot. In addition, the configuration information may be included in a higher layer signal or a physical layer signal.

In the case that the UE receives the configuration information, the UE may perform a reception, decoding, and/or processing of a downlink physical channel in a sub-slot unit and perform a reception, decoding, and/or processing of an uplink physical channel in a sub-slot unit.

For example, the first PDSCH may include PDSCHs in which HARQ-ACK transmission slot is indicated by a specific slot among PDSCHs received in a first sub-slot of each slot, the second PDSCH may include PDSCHs in which HARQ-ACK transmission slot is indicated by the specific slot among PDSCHs received in a second sub-slot of each slot, the Uplink Physical Channel may include a first Uplink Physical Channel transmitted in the first sub-slot of the specific slot and a second Uplink Physical Channel transmitted in the second sub-slot of the specific slot, and the first Uplink Physical Channel may include the HARQ-ACK information for the first PDSCH, and the second Uplink Physical Channel may include the HARQ-ACK information for the second PDSCH. Here, the fact that the HARQ-ACK transmission slot is indicated by a specific slot may mean that a HARQ-ACK transmission timing (or processing time) of the corresponding PDSCH is determined and/or configured with a specific slot.

As another example, the first PDSCH may be received in a first slot and the second PDSCH may be received in a second slot. At this time, the Uplink Physical Channel may include a first Uplink Physical Channel transmitted in a third sub-slot in a specific slot and a second Uplink Physical Channel transmitted in a fourth sub-slot in a specific slot, the first Uplink Physical Channel may include the HARQ-ACK information for the first PDSCH and the second Uplink Physical Channel may include the HARQ-ACK information for the second PDSCH. In other words, in the same slot, the UE may transmit the first Uplink Physical Channel including the HARQ-ACK information for the first PDSCH in the first sub-slot and the second Uplink Physical Channel including the HARQ-ACK information for the second PDSCH in the second sub-slot. At this time, a timing offset between the first sub-slot and the third sub-slot and/or a timing offset between the second sub-slot and the fourth sub-slot may be transmitted with the number of sub-slots (or the number of slots, the number of symbols) through a higher layer signal or a physical layer signal, or determined and/or configured according to a processing time of the PDSCH (the first PDSCH or the second PDSCH), and/or the service property of the PDSCH. In other words, the timing offset may be determined and/or configured differently for each PDSCH which is received in each sub-slot.

And/or, the first sub-slot and the second sub-slot may be included in the same slot which is different from the specific slot (the slot including the third sub-slot and the fourth sub-slot). At this time, a timing offset (or PDSCH processing time) between the slot including the first sub-slot and the second sub-slot and the slot including the third sub-slot and the fourth sub-slot may be transmitted through a higher layer signal or a physical layer signal (e.g., DCI) with the number of sub-slots (or the number of slots, the number of symbols) or determined and/or configured according to the processing time of the PDSCH (the first PDSCH or the second PDSCH), and/or the service type of the PDSCH.

Here, the first Uplink Physical Channel and the second Uplink Physical Channel may mean a PUCCH based on different PUCCH formats or a PUCCH to which at least one of a frequency based on the same PUCCH format (e.g., PRB index), a time (e.g., symbol index), and/or a code (e.g., cyclic shift, orthogonal cover code sequence) is configured as different value. For example, different PUCCH formats may be PUCCH formats of which Resource Element (RE) to which uplink control information (UCI) and/or demodulation reference signal (DMRS) is mapped and/or symbol structure is different.

And/or, in the case that UCI is transmitted through a Physical Uplink Shared Channel (PUSCH), a PUSCH transmission may also be regarded as different PUCCHs and/or PUCCH formats.

And/or, a PUCCH may be distinguished based on a time resource configured for a PUSCH transmission, a frequency resource, a duration time, and/or a PUSCH DM-RS mapping type.

The operation method of the base station shown in FIG. 11 is the same as the operation method of the base station described referring to FIG. 1 to FIG. 11, and the detailed description is omitted.

In relation to this, the operation of the base station described above may be implemented particularly by the base station 1210 shown in FIG. 12. For example, the operation of the base station described above may be performed by a processor 1211 and/or an RF unit 1213.

Referring to FIG. 12, first, the processor 1211 may transmit a Physical Downlink Shared Channel (PDSCH) to a UE via the RF unit 1213 (step, S1101).

The PDSCH may include a first PDSCH related to a first service type and a second PDSCH related to a second service type.

Here, the service type may be distinguished by a service requirement, a Transmission Time Interval (TTI) length, a numerology and/or a processing time. In other words, the first PDSCH related to the first service type may be a PDSCH that has different Transmission Time Unit, numerology and/or processing time from the second PDSCH related to the second service type. In the present disclosure, a transmission time interval may be used as the same meaning of a transmission time unit.

In a particular example, the first service type may be a service type that requires ultra-high reliability and very low latency, and the second service type may be a service type that has a requirement of fast transmission of many data. In other words, the first PDSCH related to the first service type may be a PDSCH that includes Ultra-Reliable and Low Latency Communications (URLLC) data, and the second PDSCH related to the second service type may be a PDSCH that includes enhanced Mobile BroadBand (eMBB) data.

The first service type and the second service type may be identified, distinguished and/or determined by a format of Downlink Control Information (DCI) that schedules the corresponding PDSCH, service type information included in the DCI, a Radio Network Temporary Identifier (RNTI) which is Cyclic Redundancy Check (CRC)-scrambled to the DCI, a Control Resource Set (CORESET) received in the DCI, CRC masking of DCI and/or a search space in which the DCI is monitored. In other words, each of the service types of PDSCHs may be indicated, defined, and/or configured explicitly or implicitly by DCI. Here, the service type information may be information that represents a service type for the PDSCH which is scheduled by DCI.

Next, the processor 1211 may receive an Uplink Physical Channel including Hybrid Automatic Repeat request (HARQ)-Acknowledgement (ACK) information for the PDSCH from the UE via the RF unit 1213 (step, S1102). Here, the Uplink Physical Channel may include a Physical Uplink Control Channel (PUCCH) or a Physical Uplink Shared Channel (PUSCH).

Distinctively, the HARQ-ACK information for the first PDSCH may be included in a HARQ-ACK codebook which is different from a HARQ-ACK codebook including the HARQ-ACK information for the second PDSCH. In other words, the data (e.g., URLLC data) related to the first service type may be transmitted to the base station with being included in a codebook different from the HARQ-ACK codebook including the HARQ-ACK information for the data (e.g., eMBB data) related to the second service type. For example, the HARQ-ACK information related to the data related to the first service type and the HARQ-ACK information related to the data related to the second service type may be indexed by different pseudo-codes and configure separate codebooks. In addition, the HARQ-ACK information related to the data related to the first service type and the HARQ-ACK information related to the data related to the second service type may be separately coded, and in the case that the dynamic codebook is configured, a Downlink Assignment Index (DAI) may be separately counted.

At this time, the HARQ-ACK codebook for the first PDSCH and the HARQ-ACK codebook for the second PDSCH may be transmitted through a single Uplink Physical Channel (e.g., a single PUCCH or a single PUSCH) in the same slot or may be transmitted different Uplink Physical Channels.

And/or, the base station may transmit a higher layer signal including a set of PDSCH processing times related to each of the service types. In other words, the higher layer signal may include a plurality of processing times (set) of the first PDSCH related to the first service type and a plurality of processing times (set) of the second PDSCH related to the second service type. Here, the PDSCH processing time may be an offset (e.g., k1) from a PDSCH reception to a HARQ-ACK transmission. And/or, the processing time may mean a time required for calculating the HARQ-ACK information for the corresponding PDSCH. In addition, the PDSCH processing time may be defined, promised and/or configured with various transmission time unit such as the number of slots, the number of sub-slots, and/or the number of symbols.

And/or, the UE may determine and/or identify a specific processing time among a plurality of processing times related to each of the service types by a format of Downlink Control Information (DCI) that schedules the PDSCH, processing time information included in the DCI, a Radio Network Temporary Identifier (RNTI) which is Cyclic Redundancy Check (CRC)-scram bled to the DCI, a Control Resource Set (CORESET) in which the DCI is received, CRC masking of DCI and/or a search space in which the DCI is monitored. Here, processing time information may be information indicating or representing a specific processing time among a plurality of processing times related to each of the service types. Alternatively, the UE may determine and/or identify a specific processing time among a plurality of processing times related to each of the service types by a higher layer signal.

The UE may determine a processing time related to each service type by a higher layer signal and/or specific information (e.g., DCI) and based on the determined processing time, transmit the HARQ-ACK information for the corresponding PDSCH to the base station.

And/or, the UE may receive configuration information for performing a transmission/reception in a sub-slot unit from the base station. The configuration information may be information that configures a Transmission Time Unit with sub-slots in a slot. In addition, the configuration information may be included in a higher layer signal or a physical layer signal.

In the case that the UE receives the configuration information, the UE may perform a reception, decoding, and/or processing of a downlink physical channel in a sub-slot unit and perform a reception, decoding, and/or processing of an uplink physical channel in a sub-slot unit.

For example, the first PDSCH may include PDSCHs in which HARQ-ACK transmission slot is indicated by a specific slot among PDSCHs received in a first sub-slot of each slot, the second PDSCH may include PDSCHs in which HARQ-ACK transmission slot is indicated by the specific slot among PDSCHs received in a second sub-slot of each slot, the Uplink Physical Channel may include a first Uplink Physical Channel transmitted in the first sub-slot of the specific slot and a second Uplink Physical Channel transmitted in the second sub-slot of the specific slot, and the first Uplink Physical Channel may include the HARQ-ACK information for the first PDSCH, and the second Uplink Physical Channel may include the HARQ-ACK information for the second PDSCH. Here, the fact that the HARQ-ACK transmission slot is indicated by a specific slot may mean that a HARQ-ACK transmission timing (or processing time) of the corresponding PDSCH is determined and/or configured with a specific slot.

As another example, the first PDSCH may be received in a first slot and the second PDSCH may be received in a second slot. At this time, the Uplink Physical Channel may include a first Uplink Physical Channel transmitted in a third sub-slot in a specific slot and a second Uplink Physical Channel transmitted in a fourth sub-slot in a specific slot, the first Uplink Physical Channel may include the HARQ-ACK information for the first PDSCH and the second Uplink Physical Channel may include the HARQ-ACK information for the second PDSCH. In other words, in the same slot, the UE may transmit the first Uplink Physical Channel including the HARQ-ACK information for the first PDSCH in the first sub-slot and the second Uplink Physical Channel including the HARQ-ACK information for the second PDSCH in the second sub-slot. At this time, a timing offset between the first sub-slot and the third sub-slot and/or a timing offset between the second sub-slot and the fourth sub-slot may be transmitted with the number of sub-slots (or the number of slots, the number of symbols) through a higher layer signal or a physical layer signal, or determined and/or configured according to a processing time of the PDSCH (the first PDSCH or the second PDSCH), and/or the service property of the PDSCH. In other words, the timing offset may be determined and/or configured differently for each PDSCH which is received in each sub-slot.

And/or, the first sub-slot and the second sub-slot may be included in the same slot which is different from the specific slot (the slot including the third sub-slot and the fourth sub-slot). At this time, a timing offset (or PDSCH processing time) between the slot including the first sub-slot and the second sub-slot and the slot including the third sub-slot and the fourth sub-slot may be transmitted through a higher layer signal or a physical layer signal (e.g., DCI) with the number of sub-slots (or the number of slots, the number of symbols) or determined and/or configured according to the processing time of the PDSCH (the first PDSCH or the second PDSCH), and/or the service type of the PDSCH.

Here, the first Uplink Physical Channel and the second Uplink Physical Channel may mean a PUCCH based on different PUCCH formats or a PUCCH to which at least one of a frequency based on the same PUCCH format (e.g., PRB index), a time (e.g., symbol index), and/or a code (e.g., cyclic shift, orthogonal cover code sequence) is configured as different value. For example, different PUCCH formats may be PUCCH formats of which Resource Element (RE) to which uplink control information (UCI) and/or demodulation reference signal (DMRS) is mapped and/or symbol structure is different.

And/or, in the case that UCI is transmitted through a Physical Uplink Shared Channel (PUSCH), a PUSCH transmission may also be regarded as different PUCCHs and/or PUCCH formats.

And/or, a PUCCH may be distinguished based on a time resource configured for a PUSCH transmission, a frequency resource, a duration time, and/or a PUSCH DM-RS mapping type.

The operation method of the base station shown in FIG. 12 is the same as the operation method of the base station described referring to FIG. 1 to FIG. 11, and the detailed description is omitted.

Overview of Device to which the Present Disclosure is Applicable

FIG. 12 illustrates an example of an internal block diagram of a wireless communication device to which the present disclosure is applicable.

Referring to FIG. 12, a wireless communication system includes a base station 1210 and a plurality of User Equipments (UEs) 1220 located in an area of the base station 1210. Hereinafter, the base station 1210 and the UE 1220 may be referred to as wireless devices.

The base station 1210 includes a processor 1211, a memory 1212, and a radio frequency (RF) unit 1213. The processor 1211 implements functions, processes, and/or methods proposed in FIGS. 1 to 11. Layers of a radio interface protocol may be implemented by the processor 1211. The memory 1212 is connected to the processor 1211 and stores various types of information for driving the processor 2111. The RF unit 2113 is connected to the processor 2111 and transmits and/or receives a radio signal.

The UE 1220 includes a processor 1221, a memory 1222, and a RF unit 1223. The processor 1221 implements functions, processes, and/or methods proposed in FIGS. 1 to 11. Layers of a radio interface protocol may be implemented by the processor 1221. The memory 1222 is connected to the processor 1221 and stores various types of information for driving the processor 1221. The RF unit 1223 is connected to the processor 1221 and transmits and/or receives a radio signal.

The memories 1212 and 1222 may be inside or outside the processors 1211 and 1221 and may be connected to the processors 1211 and 1221 through various well-known means.

The memories 1212 and 1222 may store a program for processing and control of the processors 1211 and 1221, and store input/output information temporarily.

The memories 1212 and 1222 may be utilized as a buffer.

Further, the base station 1210 and/or the UE 1220 may have a single antenna or multiple antennas.

FIG. 13 illustrates a block configuration diagram of a communication device according to an embodiment of the present disclosure.

In particular, FIG. 13 illustrates in more detail the UE illustrated in FIG. 12.

Referring to FIG. 13, the UE may include a processor (or digital signal processor (DSP)) 1310, an RF module (or RF unit) 1335, a power management module 1305, an antenna 1340, a battery 1355, a display 1315, a keypad 1320, a memory 1330, a subscriber identification module (SIM) card 1325 (which is optional), a speaker 1345, and a microphone 1350. The UE may also include a single antenna or multiple antennas.

The processor 1310 implements functions, processes, and/or methods proposed in FIGS. 1 to 12. Layers of a radio interface protocol may be implemented by the processor 1310.

The memory 1330 is connected to the processor 1310 and stores information related to operations of the processor 1310. The memory 1330 may be inside or outside the processor 1310 and may be connected to the processors 1310 through various well-known means.

A user inputs instructional information, such as a telephone number, for example, by pushing (or touching) buttons of the keypad 1320 or by voice activation using the microphone 2250. The processor 1310 receives and processes the instructional information to perform an appropriate function, such as to dial the telephone number. Operational data may be extracted from the SIM card 1325 or the memory 1330. Further, the processor 1310 may display instructional information or operational information on the display 1315 for the user's reference and convenience.

The RF module 1335 is connected to the processor 1310 and transmits and/or receives an RF signal. The processor 1310 delivers instructional information to the RF module 1335 in order to initiate communication, for example, transmit a radio signal configuring voice communication data. The RF module 1335 consists of a receiver and a transmitter to receive and transmit the radio signal. The antenna 1340 functions to transmit and receive the radio signal. Upon reception of the radio signal, the RF module 1335 may transfer a signal to be processed by the processor 1310 and convert the signal into a baseband. The processed signal may be converted into audible or readable information output via the speaker 1345.

FIG. 14 illustrates an example of a RF module of a wireless communication device to which a method proposed by the present specification is applicable.

More specifically, FIG. 14 illustrates an example of an RF module that can be implemented in a frequency division duplex (FDD) system.

First, in a transmission path, the processor illustrated in FIGS. 12 and 13 processes data to be transmitted and provides an analog output signal to a transmitter 1410.

In the transmitter 1410, the analog output signal is filtered by a low pass filter (LPF) 1411 to remove images caused by a digital-to-analog conversion (ADC), is up-converted from a baseband to an RF by an up-converter (mixer) 1412, and is amplified by a variable gain amplifier (VGA) 1413, and the amplified signal is filtered by a filter 1414, is additionally amplified by a power amplifier (PA) 1415, is routed through duplexer(s) 1450/antenna switch(es) 1460, and is transmitted through an antenna 1470.

Further, in a reception path, the antenna 1470 receives signals from the outside and provides the received signals, and the signals are routed through the antenna switch(es) 1460/duplexers 1450 and are provided to a receiver 1420.

In the receiver 1420, the received signals are amplified by a low noise amplifier (LNA) 1423, are filtered by a bans pass filter 1424, and are down-converted from the RF to the baseband by a down-converter (mixer) 1425.

The down-converted signal is filtered by a low pass filter (LPF) 1426 and is amplified by a VGA 1427 to obtain an analog input signal, and the analog input signal is provided to the processor illustrated in FIGS. 12 and 13.

Further, a local oscillator (LO) generator 1440 generates transmitted and received LO signals and provides them to the up-converter 1412 and the down-converter 1425, respectively.

In addition, a phase locked loop (PLL) 1430 receives control information from the processor in order to generate the transmitted and received LO signals at appropriate frequencies and provides control signals to the LO generator 1440.

The circuits illustrated in FIG. 14 may be arranged differently from the configuration illustrated in FIG. 14.

FIG. 15 illustrates another example of a RF module of a wireless communication device to which a method proposed by the present specification is applicable.

More specifically, FIG. 15 illustrates an example of an RF module that can be implemented in a time division duplex (TDD) system.

A transmitter 1510 and a receiver 1520 of the RF module in the TDD system have the same structure as the transmitter and the receiver of the RF module in the FDD system.

Hereinafter, only the structure of the RF module of the TDD system that differs from the RF module of the FDD system will be described, and the same structure will refer to the description of FIG. 15.

A signal amplified by a power amplifier (PA) 1515 of the transmitter 1510 is routed through a band select switch 1550, a band pass filter (BPF) 1560, and antenna switch(es) 1570 and is transmitted via an antenna 1580.

Further, in a reception path, the antenna 1580 receives signals from the outside and provides the received signals, and the signals are routed through the antenna switch(es) 1570, the band pass filter 1560, and the band select switch 1550 and are provided to the receiver 1520.

FIG. 16 is a diagram illustrating an example of a signal processing module to which the methods proposed in the present disclosure is applicable.

FIG. 16 shows an example of a signal processing module structure in a transmission device.

Hereinafter, the UE or the base station of FIG. 12 may be referred to be a transmission device or a reception device.

Here, a signal processing may be performed by a processor of the base station/UE, such as the processors 1211 and 1221 of FIG. 12.

Referring to FIG. 16, the transmission device included in the UE or the base station may include scramblers 1601, modulators 1602, a layer mapper 1603, an antenna port mapper 1604, resource block mappers 1605 and signal generators 1606.

The transmission device may transmit one or more codewords. Coded bits in each codeword are scrambled by the corresponding scramblers 1601 and transmitted over a physical channel. A codeword may be referred to as a data string and may be equivalent to a transport block which is a data block provided by the MAC layer.

Scrambled bits are modulated into complex-valued modulation symbols by the modulators 1602. The modulators 1602 may modulate the scrambled bits according to a modulation scheme to arrange complex-valued modulation symbols that represent positions on a signal constellation. The modulation scheme is not limited and m-PSK (m-Phase Shift Keying) or m-QAM (m-Quadrature Amplitude Modulation) may be used to modulate the coded data. The modulator may be referred to as a modulation mapper.

The complex-valued modulation symbols may be mapped to one or more transport layers by the layer mapper 1603. The complex-valued modulation symbols on each layer may be mapped by the antenna port mapper 1604 for transmission on an antenna port.

The resource block mappers 1605 may map the complex-valued modulation symbols with respect to each antenna port to appropriate resource elements in a virtual resource block allocated for transmission. The resource block mapper may map the virtual resource block to a physical resource block according to an appropriate mapping scheme. The resource block mapper 1605 may allocate the complex-valued modulation symbols with respect to each antenna port to appropriate subcarriers and multiplex the complex-valued modulation symbols according to a user.

The signal generators 1606 may modulate the complex-valued modulation symbols with respect to each antenna port, that is, antenna-specific symbols, according to a specific modulation scheme, for example, Orthogonal Frequency Division Multiplexing (OFDM), to generate a complex-valued time domain OFDM symbol signal. The signal generator may perform Inverse Fast Fourier Transform (IFFT) on the antenna-specific symbols, and a cyclic Prefix (CP) may be inserted into time domain symbols on which IFFT has been performed. OFDM symbols are subjected to digital-analog conversion and frequency up-conversion and then transmitted to the reception device through each transmission antenna. The signal generator may include an IFFT module, a CP inserting unit, a digital-to-analog converter (DAC) and a frequency upconverter.

FIG. 17 is a diagram illustrating another example of a signal processing module to which the methods proposed in the present disclosure is applicable.

FIG. 17 shows another example of a signal processing module structure in a base station or a UE. Here, signal processing may be performed by a processor of the UE/base station, such as the processors 1211 and 1221 of FIG. 12.

Referring to FIG. 17, a transmission device included in the UE or the base station may include scramblers 1701, modulators 1702, a layer mapper 1703, a precoder 1704, resource block mappers 1705 and signal generators 1706.

The transmission device may scramble coded bits in a codeword by the scramblers 1701 and then transmit the scrambled coded bits through a physical channel.

Scrambled bits are modulated into complex-valued modulation symbols by the modulators 1702. The modulator may modulate the scrambled bits according to a predetermined modulation scheme to arrange the complex-valued modulation symbols representing positions on a signal constellation. The modulation scheme is not limited and pi/2-BPSK (pi/2-Binary Phase Shift Keying), m-PSK (m-Phase Shift Keying) or m-QAM (m-Quadrature Amplitude Modulation) may be used to modulate the coded data.

The complex-valued modulation symbols may be mapped to one or more transport layers by the layer mapper 1703.

The complex-valued modulation symbols on each layer may be precoded by the precoder 1704 for transmission on an antenna port. Here, the precoder may perform transform precoding on the complex-valued modulation symbols and then perform precoding. Alternatively, the precoder may perform precoding without performing transform precoding. The precoder 1704 may process the complex-valued modulation symbols according to MIMO using multiple transmission antennas to output antenna-specific symbols and distribute the antenna-specific symbols to the corresponding resource block mapper 1705. An output z of the precoder 1704 may be obtained by multiplying an output y of the layer mapper 1703 by N×M precoding matrix W. Here, N is the number of antenna ports and M is the number of layers.

The resource block mapper 1705 maps the complex-valued modulation symbols with respect to each antenna port to appropriate resource elements in a virtual resource block allocated for transmission.

The resource block mapper 1705 may allocate the complex-valued modulation symbols to appropriate subcarriers and multiplex the complex-valued modulation symbols according to a user.

The signal generator 1706 may modulate the complex-valued modulation symbols according to a specific modulation scheme, for example, OFDM, to generate a complex-valued time domain Orthogonal Frequency Division Multiplexing (OFDM) symbol signal. The signal generator 1706 may perform Inverse Fast Fourier Transform (IFFT) on antenna-specific symbols, and a cyclic Prefix (CP) may be inserted into time domain symbols on which IFFT has been performed. OFDM symbols are subjected to digital-analog conversion and frequency up-conversion and then transmitted to the reception device through each transmission antenna. The signal generator 1706 may include an IFFT module, a CP inserting unit, a digital-to-analog converter (DAC) and a frequency upconverter.

The signal processing procedure of the reception device may be reverse to the signal processing procedure of the transmission device. Specifically, the processor of the transmission device decodes and demodulates radio signals received through antenna ports of an exterior RF unit. The reception device may include a plurality of reception antennas, and signals received through the reception antennas are restored to baseband signals, and then multiplexed and demodulated according to MIMO to be restored to a data string intended to be transmitted by the transmission device. The reception device may include a signal restoration unit for restoring received signals to baseband signals, a multiplexer for combining and multiplexing received signals, and a channel demodulator for demodulating multiplexed signal strings into corresponding codewords. The signal restoration unit, the multiplexer and the channel demodulator may be configured as an integrated module or independent modules for executing functions thereof. More specifically, the signal restoration unit may include an analog-to-digital converter (ADC) for converting an analog signal into a digital signal, a CP removal unit for removing a CP from the digital signal, an FET module for applying FFT (fast Fourier transform) to the signal from which the CP has been removed to output frequency domain symbols, and a resource element demapper/equalizer for restoring the frequency domain symbols to antenna-specific symbols. The antenna-specific symbols are restored to transport layers by the multiplexer and the transport layers are restored by the channel demodulator to codewords intended to be transmitted by the transmission device.

A radio device in the present specification may be a base station, a network node, a transmitter UE, a receiver UE, a radio device, a wireless communication device, a vehicle, a vehicle with an automatic driving function, a drone (unmanned aerial vehicle (UAV)), an artificial intelligence (AI) module, a robot, an augmented reality (AR) device, a virtual reality (VR) device, an MTC device, an IoT device, a medical device, a FinTech device (or financial device), a security device, a climate/environment device, or a device related to the fourth industrial revolution field or 5G service, or the like. For example, the drone may be an airborne vehicle that flies by a radio control signal without a person being on the flight vehicle. For example, the MTC device and the IoT device may be a device that does not require a person's direct intervention or manipulation, and may include a smart meter, a vending machine, a thermometer, a smart bulb, a door lock, a variety of sensors, or the like. For example, the medical device may be a device used for the purpose of diagnosing, treating, reducing, handling or preventing a disease and a device used for the purpose of testing, substituting or modifying a structure or function, and may include a device for medical treatment, a device for operation, a device for (external) diagnosis, a hearing aid, or a device for a surgical procedure, or the like. For example, the security device may be a device installed to prevent a possible danger and to maintain safety, and may include a camera, CCTV, a black box, or the like. For example, the FinTech device may be a device capable of providing financial services, such as mobile payment, and may include a payment device, point of sales (POS), or the like. For example, the climate/environment device may refer to a device for monitoring and predicting the climate/environment.

The UE in the present specification may include a cellular phone, a smart phone, a laptop computer, a digital broadcast terminal, a personal digital assistants (PDA), a portable multimedia player (PMP), a navigator, a slate PC, a tablet PC, an ultrabook, a wearable device (e.g., a smart watch, a smart glass, a head mounted display (HMD)), a foldable device, or the like. For example, the HMD may be a display device which is worn on the head, and may be used to implement the VR or AR device.

The embodiments described above are implemented by combinations of components and features of the present disclosure in predetermined forms. Each component or feature should be considered selectively unless specified separately. Each component or feature may be carried out without being combined with another component or feature. Moreover, some components and/or features are combined with each other and can implement embodiments of the present disclosure. The order of operations described in embodiments of the present disclosure may be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present disclosure can be embodied in other specific forms without departing from essential features of the present disclosure. Accordingly, the aforementioned detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

### INDUSTRIAL APPLICABILITY

The method of transmitting and receiving an uplink physical control channel in a wireless communication system of the present disclosure applied to a 3GPP LTE/LTE-A system and 5G system (New RAT system) is primarily described as an example but may be applied to various wireless communication systems in addition to the 3GPP LTE/LTE-A system and 5G system (New RAT system).

1. A method of transmitting, a user equipment (UE), an Uplink Physical Channel in a wireless communication system, the method comprising:
receiving, from a base station, a Physical Downlink Shared Channel (PDSCH); and
transmitting, to the base station, the Uplink Physical Channel including Hybrid Automatic Repeat request (HARQ)-Acknowledgement (ACK) information for the PDSCH,
wherein the PDSCH includes a first PDSCH related to a first service type and a second PDSCH related to a second service type, and
wherein the HARQ-ACK information for the first PDSCH is included in a HARQ-ACK codebook which is different from a HARQ-ACK codebook including the HARQ-ACK information for the second PDSCH.

2. The method of claim 1, wherein the first PDSCH includes a Transmission Time Unit, a numerology, or a processing time which is different from that of the second PDSCH.

3. The method of claim 1, wherein the first service type and the second service type are determined by a format of Downlink Control Information (DCI) that schedules a PDSCH, service type information included in the DCI, a Radio Network Temporary Identifier (RNTI) CRC-scrambled in the DCI, a Control Resource Set (CORESET) in which the DCI is received or a search space in which the DCI is monitored.

4. The method of claim 1, further comprising receiving a higher layer signal including a set of PDSCH processing times related to each service type.

5. The method of claim 1, further comprising receiving, from the base station, configuration information for performing transmission and reception in a sub-slot unit.

6. The method of claim 5, wherein the first PDSCH includes PDSCHs in which HARQ-ACK transmission slot is indicated as a specific slot among PDSCHs received in a first sub-slot of each slot,
wherein the second PDSCH includes PDSCHs in which HARQ-ACK transmission slot is indicated as the specific slot among PDSCHs received in a second sub-slot of each slot,
wherein the Uplink Physical Channel includes a first Uplink Physical Channel transmitted in the first sub-slot of the specific slot and a second Uplink Physical Channel transmitted in the second sub-slot of the specific slot, and
wherein the first Uplink Physical Channel includes the HARQ-ACK information for the first PDSCH, and the second Uplink Physical Channel includes the HARQ-ACK information for the second PDSCH.

7. The method of claim 1, wherein the Uplink Physical Channel includes a Physical Uplink Control Channel (PUCCH) or a Physical Uplink Shared Channel (PUSCH).

8. A User Equipment (UE) for transmitting an Uplink Physical Channel in a wireless communication system, the UE comprising:
a Radio Frequency (RF) Unit for transmission and receiving a radio signal; and
a processor functionally connected to the RF unit,
wherein the processor is configured to:
receive, from a base station, a Physical Downlink Shared Channel (PDSCH); and
transmit, to the base station, the Uplink Physical Channel including Hybrid Automatic Repeat request (HARQ)-Acknowledgement (ACK) information for the PDSCH,
wherein the PDSCH includes a first PDSCH related to a first service type and a second PDSCH related to a second service type, and
wherein the HARQ-ACK information for the first PDSCH is included in a HARQ-ACK codebook which is different from a HARQ-ACK codebook including the HARQ-ACK information for the second PDSCH.

9. The UE of claim 8, wherein the first PDSCH includes a Transmission Time Unit, a numerology, or a processing time which is different from that of the second PDSCH.

10. The UE of claim 8, wherein the first service type and the second service type are determined by a format of Downlink Control Information (DCI) that schedules a PDSCH, service type information included in the DCI, a Radio Network Temporary Identifier (RNTI) CRC-scrambled to the DCI, a Control Resource Set (CORESET) in which the DCI is received or a search space in which the DCI is monitored.

11. The UE of claim 8, wherein the processor is controlled to receive, from the base station, configuration information for performing transmission and reception in a sub-slot unit.

12. The UE of claim 8, wherein the Uplink Physical Channel includes a Physical Uplink Control Channel (PUCCH) or a Physical Uplink Shared Channel (PUSCH).

13. A base station (BS) for receiving an Uplink Physical Channel in a wireless communication system, the BS comprising:
a Radio Frequency (RF) Unit for transmission and receiving a radio signal; and
a processor functionally connected to the RF unit,
wherein the processor is configured to:
transmit, to a User Equipment, a Physical Downlink Shared Channel (PDSCH); and
receive, from the User Equipment, the Uplink Physical Channel including Hybrid Automatic Repeat request (HARQ)-Acknowledgement (ACK) information for the PDSCH,
wherein the PDSCH includes a first PDSCH related to a first service type and a second PDSCH related to a second service type, and
wherein the HARQ-ACK information for the first PDSCH is included in a HARQ-ACK codebook which is different from a HARQ-ACK codebook including the HARQ-ACK information for the second PDSCH.

14. The BS of claim 13, wherein the first PDSCH includes a Transmission Time Unit, a numerology, or a processing time which is different from that of the second PDSCH.

15. The BS of claim 13, wherein the Uplink Physical Channel includes a Physical Uplink Control Channel (PUCCH) or a Physical Uplink Shared Channel (PUSCH).
